(19) United States
(12) Patent Application Publication
(10) Pub. No.: US 2012/0254583 A1
(43) Pub. Date: Oct. 4, 2012

(54) STORAGE CONTROL SYSTEM PROVIDING VIRTUAL LOGICAL VOLUMES COMPLYING WITH THIN PROVISIONING

(75) Inventors: Kazuyoshi Serizawa, Tama (JP); Yoshiaki Eguchi, Yokohama (JP); Norio Shimozono, Machida (JP)

(73) Assignee: Hitachi, Ltd.

(21) Appl. No.: 13/125,535

(22) PCT Filed: Mar. 31, 2011
(86) PCT No.: PCT/JP2011/001944

§ 371 Date: Apr. 21, 2011

(51) Int. Cl. G06F 12/10

(52) U.S. Cl. 711/206; 711/E12.059

(57) ABSTRACT

A storage control system comprises a storage resource and a controller. If the controller receives a write command which specifies an address belonging to a virtual volume, to the area belonging to the address, unassigned pages in a pool which is a storage area based on a plurality of media types of physical storage media and which is divided into a plurality of pages are supposed to be assigned. The storage control system comprises a plurality of management entries which are a plurality of entries for page management information which is the information related to the pages. The plurality of management entries include two or more page entries and two or more statistical entries. A statistical entry about a certain media type corresponds to M pages based on the storage media of the certain media type (M is an integral number which is 2 or larger). The statistical entry corresponding to the M pages comprises the information related to the I/O performance value for those M pages.

### TECHNICAL FIELD

The present invention relates to storage control to which Thin Provisioning (also referred to as Dynamic Provisioning) is applied.

### BACKGROUND ART

The technology referred to as Thin Provisioning (also referred to as Dynamic Provisioning) is known (e.g. Patent Literature 1). According to Thin Provisioning, virtual logical volumes (virtual volumes) and a pool are prepared. The pool is an actual storage area and is divided into a plurality of sub-areas (pages). The pages are assigned to the virtual area (virtual storage area) belonging to an address in the virtual volumes which is specified as a write destination, and write target data is written to the assigned page.

### CITATION LIST

### Patent Literature

PTL 1: Japanese Patent Application Laid-Open No. 2003-015915

### SUMMARY OF INVENTION

### Technical Problem

Storage control apparatuses generally comprise storage resources (typically, memories). The storage resources store information related to the pages (hereinafter referred to as management information). The management information comprises entries per page (hereinafter referred to as management entries)

Normally, the page size and the management entry size are fixed. For this reason, if the page size is small, the number of pages in the pool is large, and therefore the number of management entries is also large. Therefore, the size of page management information is large. However, generally, there is an upper limit on the size of the page management information. For this reason, there is an upper limit on the number of management entries, and therefore the number of pages is limited. Therefore, if the page size is small, the supportable capacity (maximum pool size) might be small.

For a large supportable capacity, a large page size is necessary. However, if the page size is large, the capacity efficiency is not good.

Therefore, the purpose of the present invention is to inhibit both the deterioration of the capacity efficiency and the reduction of the supportable capacity.

### Solution to Problem

The storage control system comprises a storage resources and a controller. If the controller receives a write command which specifies an address belonging to the virtual volume, to the area belonging to the address, unassigned pages in the pool which is a storage area based on a plurality of media types of physical storage media and is divided into a plurality of pages are supposed to be assigned. The storage control system comprises a plurality of management entries which are a plurality of entries for page management information which is the information related to pages. The plurality of management entries include two or more page entries and two or more statistical entries. A statistical entry about a certain media type corresponds to M pages based on the storage media of the certain media type (M is an integral number which is 2 or larger). The statistical entry corresponding to the M pages comprises the information related to the I/O performance value for those M pages. The I/O performance value is a value related to the I/O performance of the page area and may be, for example, an I/O frequency, a data transfer rate, or a response time.

### BRIEF DESCRIPTION OF DRAWINGS

FIG. 1 shows the configuration of a storage system related to the Embodiment 1 of the present invention.

FIG. 2 shows the relationship among respective storage areas in the storage system 103.

FIG. 3A shows the overview of a first characteristic of the Embodiment 1. FIG. 3B shows the overview of a second characteristic of the Embodiment 1.

FIG. 4 shows the computer programs which a storage resource 153 of a management computer 107 stores.

FIG. 5 shows the information and computer programs which a CMPK 119 stores.

FIG. 6 shows the configuration of a pool management table 503.

FIG. 7 shows the configuration of a tier management table 504.

FIG. 8 shows the configuration of a pool VOL management table 505.

FIG. 9 shows the configuration of a media setting value table 507.

FIG. 10 shows the configuration of a VOL management table 508.

FIG. 11 shows the configuration of a free entry group 506.

FIG. 12 shows the configuration of a media I/O frequency table 509.

FIG. 13 shows the configuration of a reallocation management table 510.

FIG. 14A shows the configuration of a free entry management table 511. FIG. 14B shows the configuration of a default value table 512.

FIG. 15A shows the configuration of a page entry group 501. FIG. 15B shows a variation example of page entry group 501.

FIG. 16A shows the configuration of a statistical entry group 502. FIG. 16B shows the correspondence relationship between statistical entries and pages. FIG. 16C shows a variation example of statistical entry group.

FIG. 17 shows the flow of the processing performed by a default value setting program 403.

FIG. 18 shows a first part of the flow of the processing performed by a pool setting program 401.

FIG. 19A shows a second part of the flow of the processing performed by the pool setting program 401. FIG. 19B shows the rest of the flow of the processing performed by the pool setting program 401.

FIG. 20 shows a first part of the flow of the processing performed by a VOL setting program 402.

FIG. 21A shows a second part of the flow of the processing performed by the VOL setting program 402. FIG. 21B shows the rest of the flow of the processing performed by the VOL setting program 402.

FIG. 22 shows the flow of the processing performed by a default value management program 517.

FIG. 23 shows a first part of the flow of the processing performed by a pool management program 514.

FIG. 24A shows a second part of the flow of the processing performed by the pool management program 514. FIG. 24B shows the rest of the flow of the processing performed by the pool management program 514.

FIG. 25 shows a first part of the flow of the processing performed by a VOL management program 515.

FIG. 26A shows a second part of the flow of the processing performed by the VOL management program 515. FIG. 26B shows the rest of the flow of the processing performed by the VOL management program 515.

FIG. 27 shows the flow of the processing performed by an I/O processing program 513.

FIG. 28 shows the flow of the statistical entry processing (S2702 or S2713 in FIG. 27) related to the Embodiment 1.

FIG. 29 shows the flow of the processing performed by a reallocation program S16.

FIG. 30 shows the flow of the reallocation processing (S2902 in FIG. 29).

FIG. 31A shows an example of a default value input screen. FIG. 31B shows an example of the default value input screen on which parameters ascertained by a program are displayed.

FIG. 32 shows an example of the default value input screen on which the input of an unappropriate parameter value is forbidden.

FIG. 33A shows a first variation example of the default value input screen. FIG. 33B shows a second variation example of the default value input screen.

FIG. 34 shows the flow of the statistical entry processing related to the Embodiment 2.

FIG. 35 shows the flow of the statistical entry processing related to the Embodiment 3.

FIG. 36 shows the flow of the processing performed in case the request at S1801 in FIG. 18 in the Embodiment 4 is a pool VOL addition request.

FIG. 37 shows an example of the screen displayed at S3603 in FIG. 36.

### DESCRIPTION OF EMBODIMENTS

Hereinafter, with reference to the figures, some of the embodiments of the present invention are explained.

It should be noted that each type of information might be explained by the expression of an “xxx table” hereinafter, but may also be expressed in other types of data configuration than tables. For indicating that the information is not depending on the data configuration, the “xxx table” can be referred to as “xxx information.”

Furthermore, in the explanation below, the processing might be explained by a “computer program” as a subject, but the subject of the processing may also be a controller or a processor because the program performs the specified processing by being performed by the processor which the controller comprises (e.g. a CPU (Central Processing Unit)) while appropriately using a storage resource (e.g. a memory) and/or a communication interface device (e.g. a communication port). The processing explained by the program as a subject may also be referred to as the processing performed by the processor or the controller comprising the processor. Furthermore, the controller may also include a hardware circuit which performs part or all of the processing in addition to the processor. The program may also be installed in each controller from a program source. The program source may also be, for example, a program distribution server or physical storage media (hereinafter referred to as media).

Furthermore, the management apparatus may be configured of one or more computers. Specifically speaking, for example, if a management computer displays information or if the management computer transmits display information to a remote computer, the management computer is a management apparatus. Furthermore, for example, if the function equivalent to the management computer is achieved by a plurality of computers, the relevant plurality of computers (a display computer may be included if the display is performed by the display computer) are the management apparatus.

Furthermore, in the explanation below, as types of identification information of various types of targets (e.g. logical volumes, RAID (Redundant Array of Independent (or Inexpensive) Disks) groups), numbers, identifiers, or names are adopted, which may be mutually replaceable, or a plurality of types of identification information may also be combined to be identification information.

Furthermore, in the explanation below, a logical volume might be abbreviated to a “VOL.”

### Embodiment 1

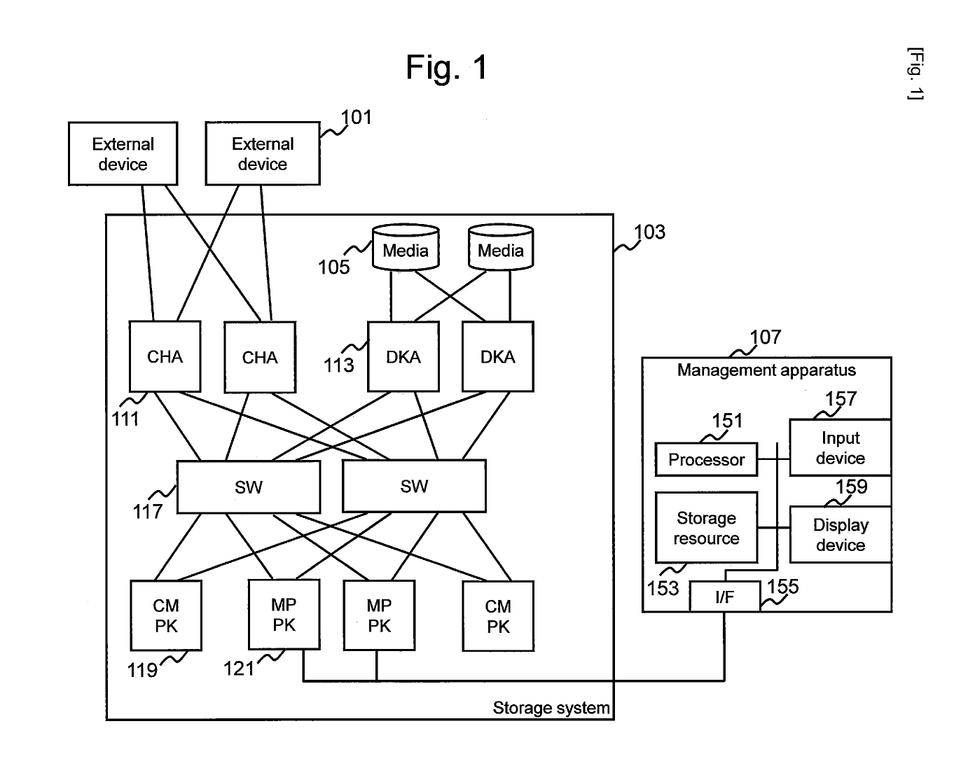

FIG. 1 shows the configuration of a storage system related to the Embodiment 1 of the present invention.

The storage system 103 comprises a plurality of media 105 and a storage control apparatus connected to the plurality of media 105.

In the plurality of media 105, a plurality of types of media, for example, SSDs (Solid State Drives) and HDDs (Hard Disk Drives) are included. HDDs are, for example, HDD-SATA (Serial ATA) and HDD-SAS (Serial Attached SCSI). Hereinafter, HDD-SATA is simply referred to as “SATA” and HDD-SAS is simply referred to as “SAS.”

The storage control apparatus comprises a lower communication interface device which is connected to the plurality of media 105, an upper communication interface device which is connected to the devices outside the storage system 103, a storage resource, and a controller connected to the same. The lower communication interface device is, for example, a plurality of DKAs (disk adapters) 113. The upper communication interface device is, for example, a plurality of CHAs (channel adapters) 111. The storage resource is, for example, a plurality of CMPKs (cache memory packages) 119. The controller comprises, for example a plurality of MPPKs (microprocessor packages) 121 and SWs (switches) 117. Two or more CHAs 111, two or more DKAs 113, two or more MPPKs 121, two or more SWs 117, and two or more CMPKs 119 exist from the perspective of redundancy, but at least one of the same may also be singular. In this embodiment, the devices outside the storage system 103 may be host devices (hereinafter referred to as hosts) 101, or may also be other storage systems.

The CHAs 111 are communication interface devices connected to the external devices. The CHAs 111 receive I/O (Input/Output) commands (write commands or read commands) from the external devices 101, and transfer the received I/O commands to any one of the plurality of MPPKs 121.

The DKAs 113 are communication interface devices connected to the media 105. The DKAs 113 read data from the media 105, transfer the same to the CMPKs 119, and write the data from the CMPKs 119 to the media 105.

The MPPKs 121 are devices comprising one or a plurality of MPs (microprocessors). The MP(s) process(es) I/O commands from the CHAs 111.

To the SWs 117, a plurality of packages, that is, the CHAs 111, the DKAs 113, the CMPKs 119, and the MPPKs 121 are connected. The SWs 117 control the connection among the PKs (packages).

The CMPKs 119 comprise volatile memories and/or non-volatile memories. In the CMPKs 119, for example, storage areas (hereinafter referred to as cache memory or CM as abbreviation of the same) where data which is the target of the I/O for the logical volumes is temporarily stored exist. Furthermore, in the CMPKs 119, the storage areas where various types of information and computer programs are stored exist. The information and the computer programs are explained later.

To the storage system 103, a management apparatus 107 is connected. The management apparatus 107 comprises a communication interface device 155, a storage resource (e.g. a memory) 153, an input device (e.g. a keyboard and a mouse) 157, a display device 159, and a processor 151 which is connected to the same. The input device 157 and the display device 159 may also be integrated. The administrator can perform various types of setting for the storage system 103 from the management apparatus 107.

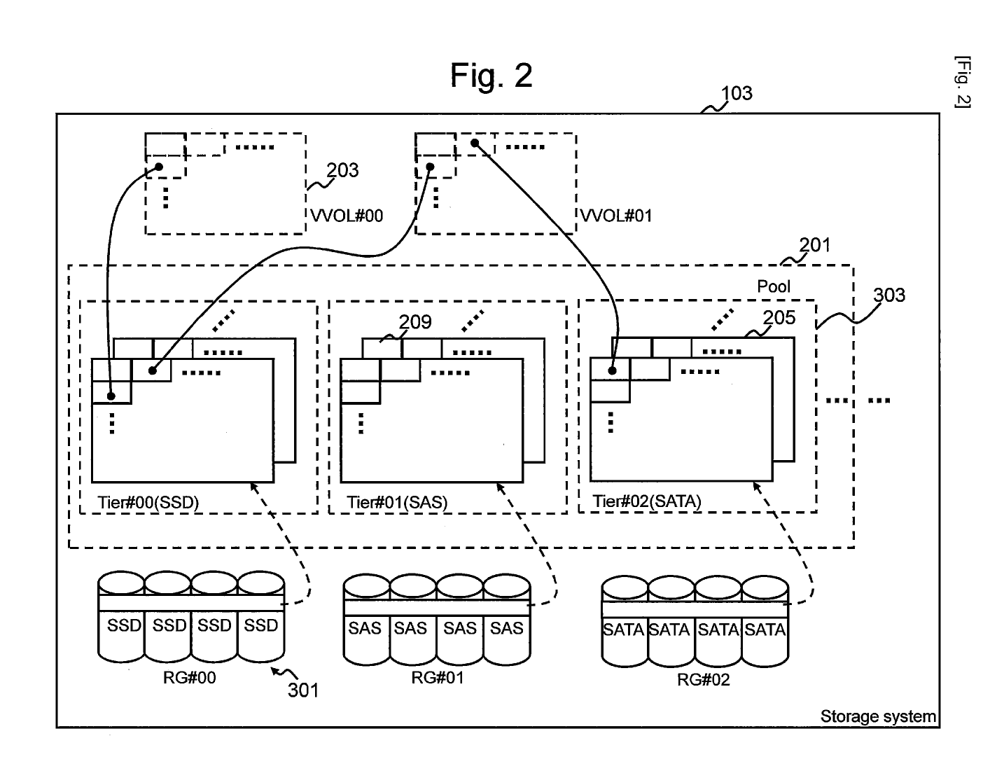

FIG. 2 shows the relationship among the various types of storage areas in the storage system 103.

One or a plurality of RGs 301, one or a plurality of pools 201, one or a plurality of VVOLs 203 are managed respectively as a low tier, a medium tier, and a high tier.

The RG 301 is an abbreviation for RAID group. An RG 301 is configured of the same type of media. The media type is defined by at least either the performance or the unit cost. The performance is, for example, the data I/O rate or the response time (the length of time since a command is received until the response is returned). The unit cost is a price required for saving the data of the unit size (e.g. a so-called a bit cost). For example, an RG #00 is configured of a plurality of SSDs, an RG #01 is configured of a plurality of SAS's, and an RG #02 is configured of a plurality of SATAs. It should be noted that the capacity of the plurality of media configuring an RG is, for example, the same.

The pool 201 is a set of pages 209. Specifically speaking, for example, the pool 201 is configured of one or more pool VOLs 205, and each of the pool VOLs 205 is divided into two or more pages 207. The pool VOLs 205 are logical volumes configuring the pool 201. The pool VOLs 205 may be actual logical volumes based on the RGs 301, or may also be virtual logical volumes to which the logical volumes provided by the external storage system are mapped.

The pages 209 configuring one pool 201 are hierarchized. Specifically speaking, a plurality of tiers 303 exist in one pool 201. The tiers 303 exist, for example, per media type based on pool VOLs. Specifically speaking, for example, a tier #00 is based on a plurality of SSDs, a tier #01 is based on a plurality of SAS's, and a tier #02 is based on a plurality of SATAs. It should be noted that the plurality of media based on a tier 303 may not have to be of strictly the same media type. For example, a tier 303 may also be based on a plurality of media of similar media types. In this embodiment, the performance and/or the unit cost is better as the tier is higher. In this embodiment, a smaller number is provided as a tier ID as the tier is higher.

The VVOLs 203 are virtual logical volumes. To a VVOL 203, a pool 201 is associated. To the area belonging to the write destination logical address (e.g. an LBA (Logical Block Address)) in the VVOL 203, a page in the pool 201 to which the VVOL 203 is associated is assigned.

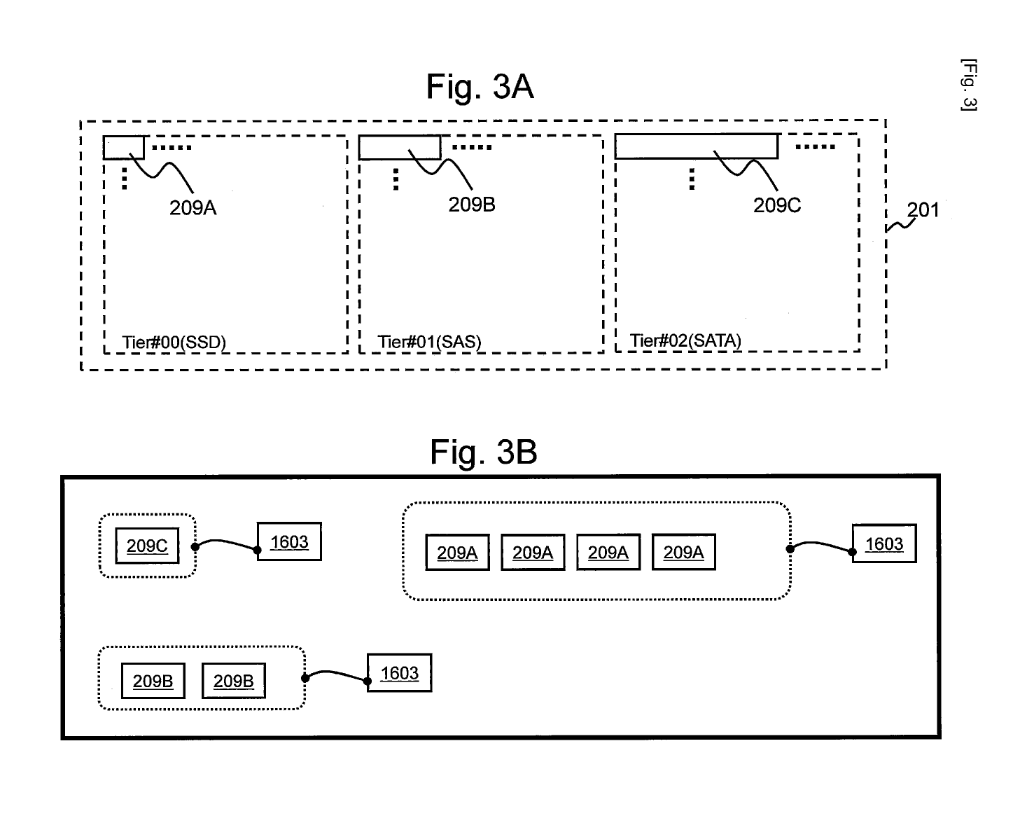

FIG. 3A shows the overview of a first characteristic of the Embodiment 1.

The page size is variable. Preferably, the page size in the higher tier is smaller than the page size in the lower tier. Specifically speaking, for example, as illustrated in FIG. 3A, the size of a page 209A in the highest tier #00 is smaller than the size of a page 209B in the second highest tier #01. Furthermore, the size of the page 209B is smaller than the size of a page 209C in the lowest tier #02.

In one tier, the page size may be equal. The page sizes in the other tiers than the tier including the page of the smallest page size may be N times as the smallest page size (N indicates an integral number which is 2 or larger).

As described above, the page size is variable. By this, saving the number of page entries and, at the same time, inhibiting the deterioration of the capacity efficiency can be expected.

FIG. 3B shows the overview of a second characteristic of the Embodiment 1.

A statistical entry 1603 corresponds to M pages (M indicates an integral number which is 1 or larger). Specifically speaking, for example, illustrated in FIG. 3B, four pages 209A correspond to a statistical entry 1603 for the tier #00, two pages 209B correspond to a statistical entry 1603 for the tier #01, and one page 209C corresponds to a statistical entry 1603 for the tier #02.

It should be noted that the statistical entry 1603 is one of the information factors in the page management information (page related information), and an example of management entry. The statistical entry 1603 corresponding to a page comprises the information indicating the I/O frequency of the page. The statistical entry 1603 corresponding to a plurality of pages comprises the information indicating the sum of the I/O frequencies of the plurality of pages as the information indicating the I/O frequency.

As described above, a plurality of pages are associated with one statistical entry. This can save the number of statistical entries.

The first and second characteristics may also be respectively independent. Specifically speaking, it may be permitted that the page size is variable while the statistical entry 1603 does not correspond to a plurality of pages or it may also be permitted that the page size is fixed while the statistical entry 1603 corresponds to a plurality of pages.

Furthermore, the first and second characteristics may also be combined as in this embodiment. In this embodiment, for each media type (e.g. for each tier), either one of the page size and the value M (M indicates the number of pages corresponding to one statistical entry 1603) can be determined in accordance with the other of the same. For example, the page size based on the higher media type is smaller than the page size based on the lower media type and, at the same time, the number of pages corresponding to the statistical entry 1603 is larger for the higher media type than for the lower media type. It should be noted that the priority of the media types (higher/lower) complies with the performance and/or the unit cost. For example, the media type of high performance is a higher media type than the media type of low performance.

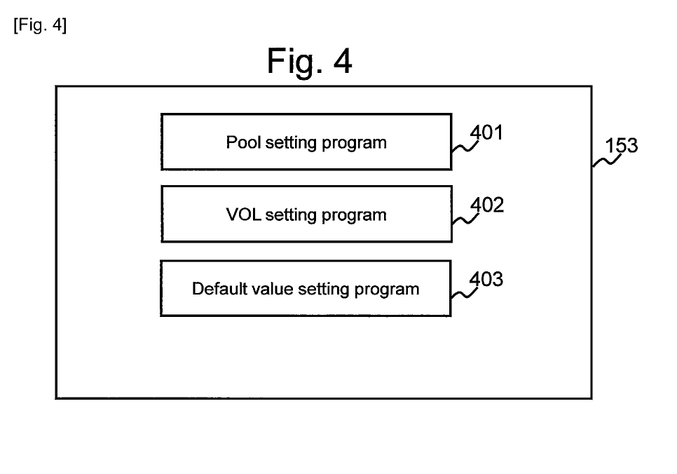

FIG. 4 shows the computer programs which the storage resource 153 of the management apparatus 107 stores.

The storage resource 153 stores a pool setting program 401, a VOL setting program 402, and a default value setting program 403. These programs from 401 to 403 are performed by the processor 151. These programs from 401 to 403 are explained later.

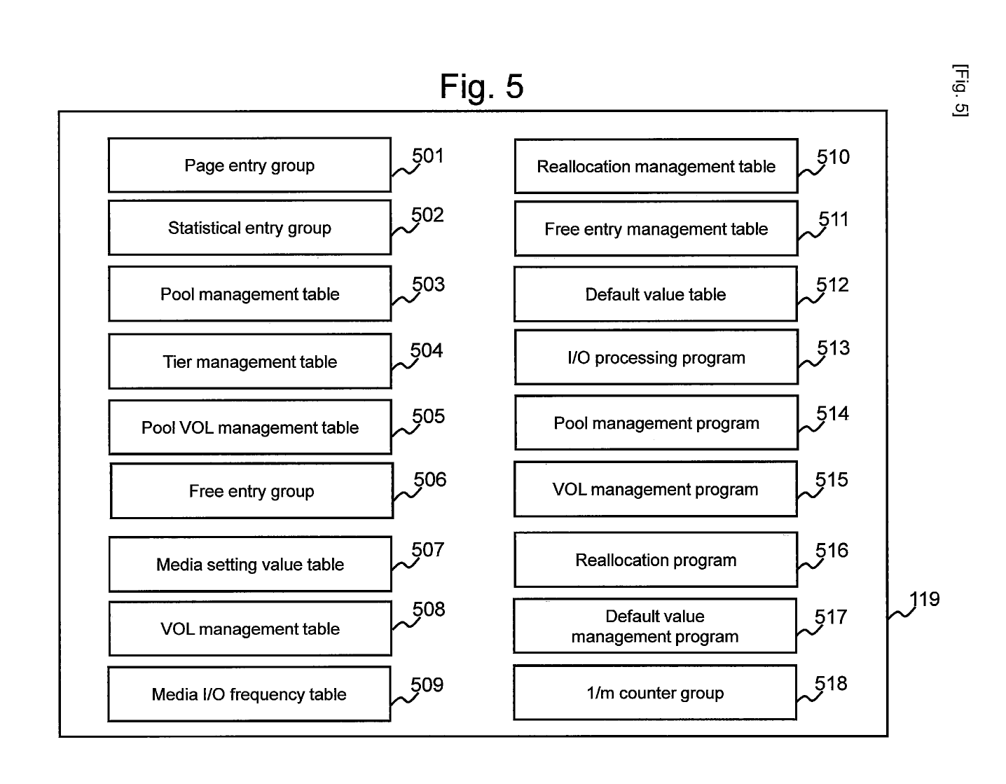

FIG. 5 shows the information and computer programs which the CMPK 119 stores.

The CMPK 119 stores as information a page entry group 501, a statistical entry group 502, a pool management table 503, a tier management table 504, a pool VOL management table 505, a free entry group 506, a media setting value table 507, a VOL management table 508, a media I/O frequency table 509, a reallocation management table 510, a free entry management table 511, and a default value table 512. Furthermore, the CMPK 119 stores as computer programs an I/O processing program 513, a pool management program 514, a VOL management program 515, a reallocation program 516, and a default value management program 517. Furthermore, in the CMPK 119, a 1/m counter group 518 is set. These types of information and tables are explained later. It should be noted that at least one of these types of information and computer programs may also be stored in other storage resources than the CMPK 119 (e.g. a storage resource in the MPPK 121).

Hereinafter, the various types of information are explained.

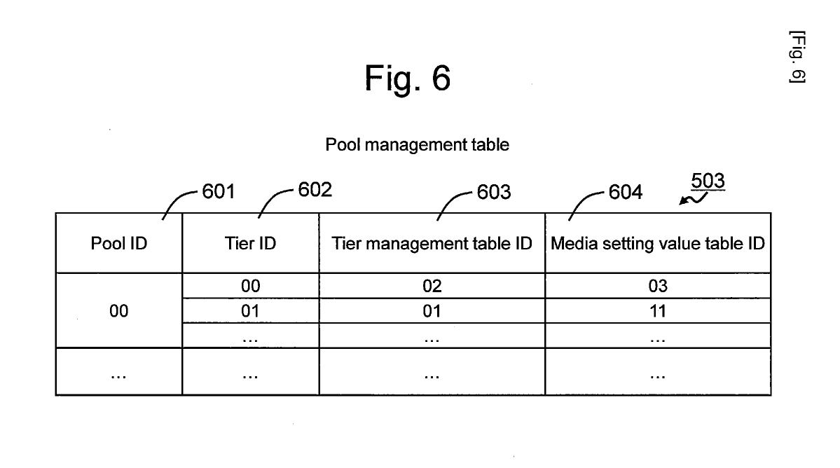

FIG. 6 shows the configuration of the pool management table 503.

The pool management table 503 comprises pool related information. Specifically speaking, for example, the pool management table 503, for each tier, comprises the information below:

(6-1) a pool ID 601 which is the identification information of a pool which comprises the tier;

(6-2) a tier ID 602 which is the identification information of the tier;

(6-3) a tier management table ID 603 which is the identification information of the tier management table 504 associated with the tier; and

(6-4) a media setting value table ID 604 which is the identification information of the media setting value table 507 associated with the tier.

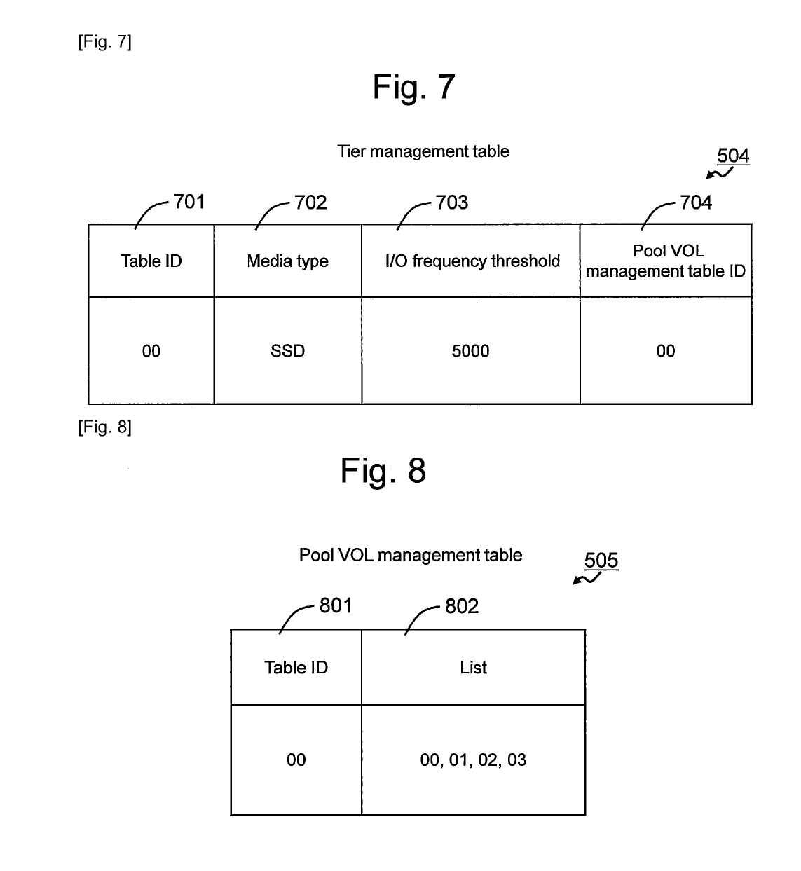

FIG. 7 shows the configuration of the tier management table 504.

The tier management table 504 is a table comprising tier related information. Specifically speaking, for example, the tier management table 504 comprises a table ID 701 which is the identification information of the table 504. Furthermore, for example, the tier management table 504, for a tier corresponding to this table 504 (hereinafter referred to as a “target tier” in the explanation of FIG. 7), comprises the information below:

(7-1) a media type 702 indicating a media type on which the tier is based;

(7-2) an I/O frequency range 703 indicating an I/O frequency threshold corresponding to the tier; and

(7-3) a pool VOL management table ID 704 which is the identification information of the pool VOL management table comprising the information related to one or more pool VOLs belonging to the tier.

The “I/O frequency threshold” is the threshold of the I/O frequency. The I/O frequency is the number of I/Os per unit time, and the unit is IOPS (I/O Per Second). According to the example in FIG. 7, if a page whose I/O frequency is less than 5000 belongs to the target tier, the data in the page is migrated to a page in a tier which is lower than the target tier (e.g. the closest tier). While each of the highest tier and the lowest tier has one I/O frequency threshold, each of the other tiers (hereinafter also referred to as “medium tiers”) has two thresholds as I/O frequency thresholds, a higher threshold and a lower threshold. If the I/O frequency of a first page in the first medium tier exceeds the higher threshold of the first medium tier, the data in the first page is migrated to a page in a higher tier than the first medium tier (e.g. the closest tier). If the I/O frequency of a second page in the first medium tier exceeds the lower threshold of the first medium tier, the data in the second page is migrated to a page in a lower tier than the first medium tier (e.g. the closest tier). It should be noted that the highest tier has a lower threshold but does not have a higher threshold, and that the lowest tier has a higher threshold but does not have a lower threshold. The higher threshold is a threshold corresponding to a higher tier (an I/O frequency threshold for [determining] whether to migrate data to the higher tier or not). The lower threshold is a threshold corresponding to a lower tier (an I/O frequency threshold for [determining] whether to migrate data to the lower tier or not). Furthermore, the higher threshold of a medium tier and the lower threshold of the highest tier may also be consistent, in which case there may also be one storage location in the management information (e.g. a table). This may also be applied to the lower thresholds of the medium tiers and the higher threshold of the lowest tier.

FIG. 8 shows the configuration of the pool VOL management table 505.

The pool VOL management table 505 is a table comprising the information related to pool VOLs. Specifically speaking, for example, the pool VOL management table 505 comprises a table ID 801 which is the identification information of the table 505. Furthermore, for example, the pool VOL management table 505 comprises a list 802 of pool VOL IDs. The list 802 comprises the IDs of one or more pool VOLs.

The pool VOL management table 505 is associated with one tier. Therefore, the ID(s) of one or more pool VOLs belonging to the tier can be ascertained from the list 802 of the pool VOL management table 505 associated with the tier.

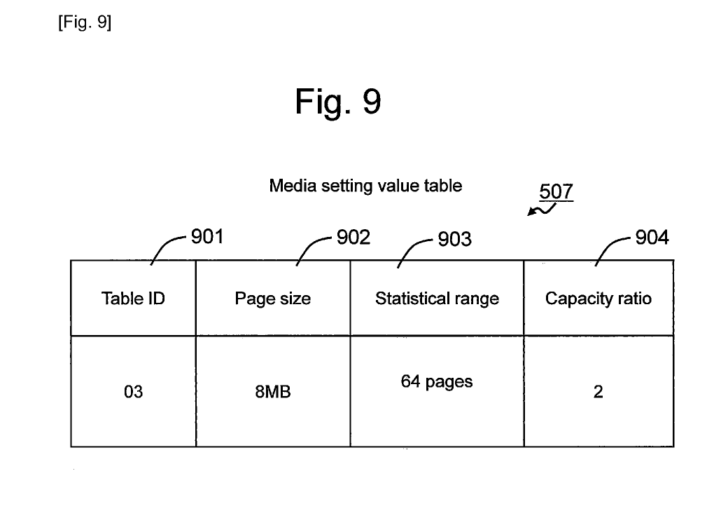

FIG. 9 shows the configuration of the media setting value table 507.

The media setting value table 507 is a table comprising the information indicating the page size and the statistical range which are set for the media type. Specifically speaking, for example, the media setting value table 507 comprises a table ID 901 which is the identification information of the table 507. Furthermore, the media setting value table 507 comprises a page size 902 which is the information indicating the page size, a statistical range 903 which is the information indicating the statistical range, and a capacity ratio 904. It should be noted that the “statistical range” is the number of pages corresponding to one statistical entry. The “capacity ratio” is the ratio of the capacity complying with the relevant media type to the entire capacity of the pool.

The media setting value table 507 corresponds to one media type and, at the same time, is associated with the tier which is based on the media of the media type (refer to FIG. 6). Therefore, according to FIG. 6 and FIG. 9, as for the tier #00 in the pool #00, the items below can be ascertained.

(a) the page size is 8 MB (megabytes),

(b) a statistical entry exists for every 64 pages, and

(c) the capacity ratio is 2%.

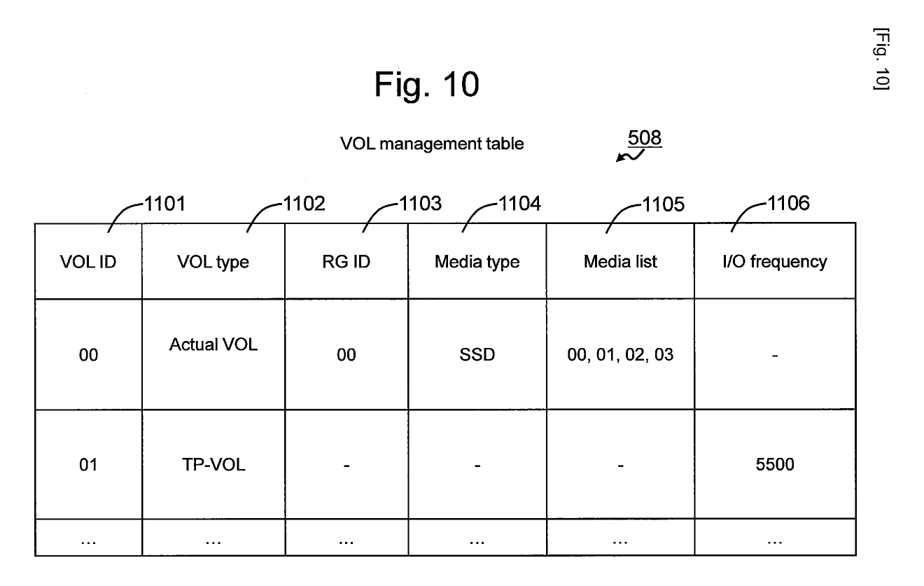

FIG. 10 shows the configuration of the VOL management table 508.

The VOL management table 508 comprises the information related to VOLs. The VOL management table 508, for example, per VOL, comprises the information below:

(10-1) a VOL ID 1101 which is the identification information of the VOL;

(10-2) a VOL type 1102 which is the information indicating the type of the VOL;

(10-3) an RG ID 1103 which is the identification information of an RG based on the VOL;

(10-4) a media type 1104 which is the information indicating the type of the media configuring the RG based on the VOL;

(10-5) a list 1105 indicating the IDs of a plurality of media configuring the RG based on the VOL; and

(10-6) an I/O frequency 1106 which is the information indicating the number of I/Os (I/O frequency) for the VOL per unit time.

The VOL types are, for example, actual VOLs which are VOLs based on the RG and TP-VOLs which are VVOL (VVOL to which the pages are assigned) complying with Thin Provisioning.

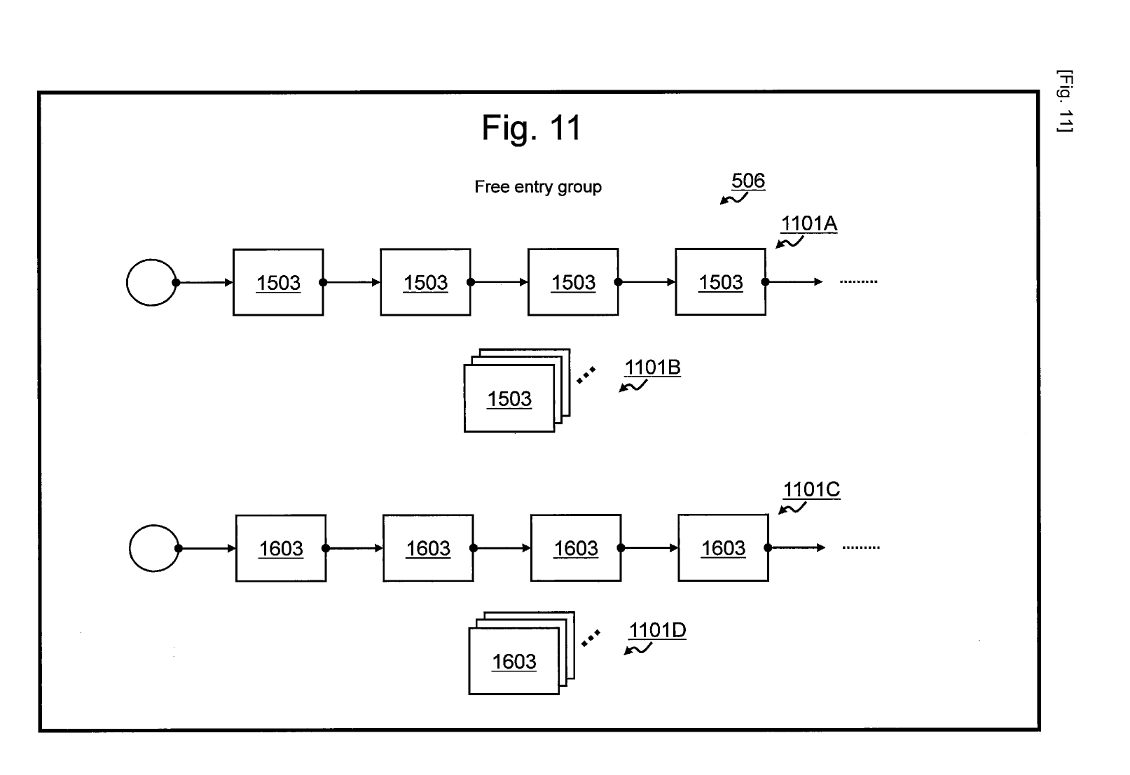

FIG. 11 shows the configuration of the free entry group 506.

The free entry group 506 comprises a free page entry queue 1101A, a free page entry group 1101B, a free statistical entry queue 1101C, and a free statistical entry group 1101D.

The free page entry queue 1101A is a queue for free page entries 1503. The page entries 1503 connected to this queue 1101A are the entries to be the factors of directories which are explained later. Hereinafter, the page entries 1503 to be the factors of the directories might be specifically referred to as “directory page entries 1503.”

The free page entry group 1101B is a set of entries 1503 which are directly associated with a page. Each entry 1503 in this entry group 1101B comprises the address (physical address) of the page which is directly associated with the entry 1503. Hereinafter, the page entry 1503 which is directly associated with the page might be specifically referred to as “direct page entries 1503.”

The statistical entry queue 1101C is a queue of free statistical entries 1603. The statistical entries 1603 connected to this queue 1101C are the entries to be the factors of directories which are explained later. Hereinafter, the statistical entries 1603 to be the factors of the directories might be specifically referred to as “directory statistical entries 1603.”

The free statistical entry group 1101D is a set of entries 1603 which are directly associated with M page(s) (M indicates an integral number which is 1 or larger). Each entry 1603 in this entry group 1101D comprises the information indicating the I/O frequency of the M page(s) which are directly associated with the entry 1603. Hereinafter, the statistical entry 1603 which is directly associated with the M page(s) might be specifically referred to as a “direct statistical entry 1603.”

The page entries 1503 and the statistical entries 1603 are examples of management entries in the page management information. The direct page entries 1503 in the free page group 506 correspond to one free page. The “free page” indicates a page which is not assigned to any VVOL and can be assigned to a VVOL.

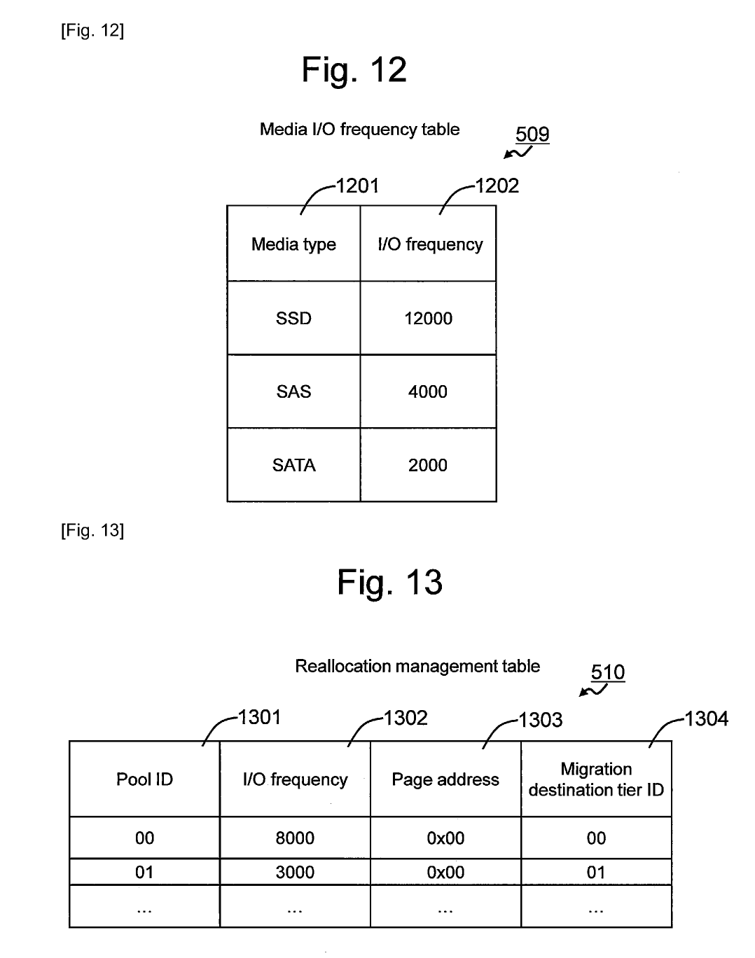

FIG. 12 shows the configuration of the media I/O frequency table 509.

The media I/O frequency table 509 comprises the information indicating the I/O frequency of each media type. The media I/O frequency table 509, for example, for each media type, comprises the information below:

(12-1) a media type 1201 indicating the media type; and

(12-2) an I/O frequency 1202 which is the information indicating the number of I/Os (I/O frequency) for the media type per unit time.

The I/O frequency 1202 of a certain media type may be the sum of the I/O frequencies of all the pages belonging to the media type.

FIG. 13 shows the configuration of the reallocation management table 510.

The reallocation management table 510 is a table comprising the information related to data migration source pages and the migration destination of the data. The real-location management table 510, for example, for each migration target, comprises the information below:

(13-1) a pool ID 1301 which is the identification information of a pool comprising a page including the migration target data;

(13-2) an I/O frequency 1302 indicating the I/O frequency corresponding to the migration target;

(13-3) a page address 1303 indicating a page address corresponding to the migration target; and

(13-4) a migration destination tier ID 1304 which is the identification information of the tier which is the migration destination of the migration target data.

For example, if the page including the migration target data (hereinafter referred to as the “target page” in the explanation of FIG. 13) is m time(s) the size of the smallest page size (m indicates an integral number which is 1 or larger), the target page corresponds to a set of m unit(s) of page area(s). The size of a “page area” referred to at this step is the smallest page size. In this case, as for the I/O frequency 1302 and the page address 1303, as follows:

(a) the I/O frequency 1302 indicates the I/O frequency corresponding to the page area including the migration target data; and

(b) the page address 1303 indicates the page address belonging to the page area including the migration target data in the page address range corresponding to the target page.

It should be noted that the reallocation management table 510 may also exist in each pool.

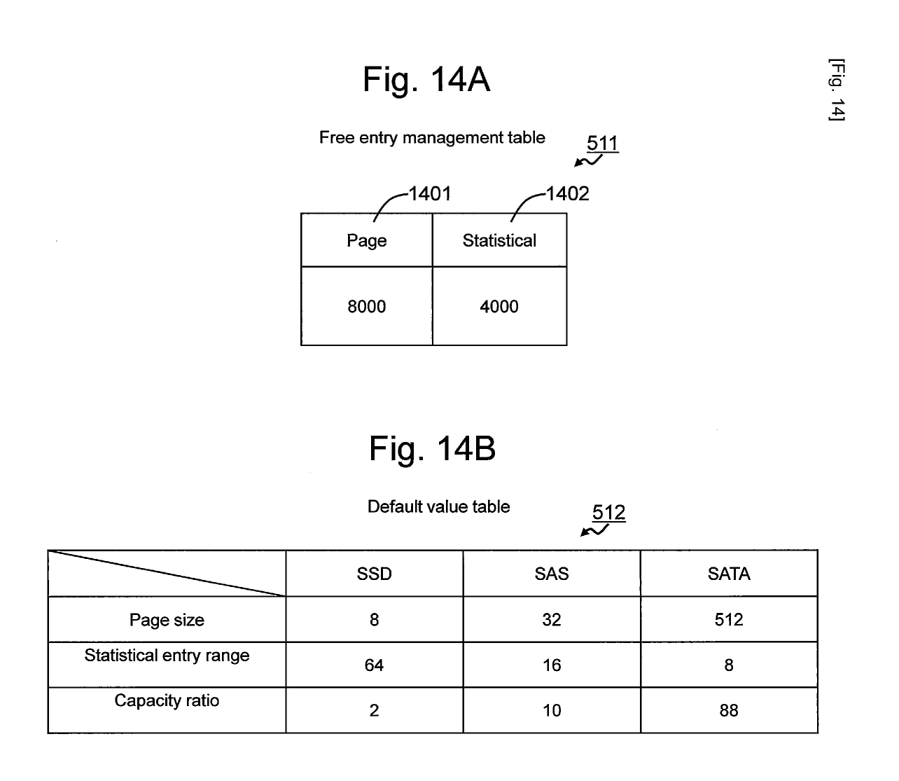

FIG. 14A shows the configuration of the free entry management table 511.

The free entry management table 511 comprises the information below:

(14A-1) a page 1401 which is the information indicating the number of free page entries (the number of free page entries connected to the free page entry queue); and

(14A-2) a statistical 1402 which is the information indicating the number of free statistical entries (the number of free statistical entries connected to the free statistical entry queue).

FIG. 14B shows the configuration of the default value table 512.

The default value table 512 is a table comprising a default value group for each media type. The media types are SSD, SAS, and SATA. The types of default values included in the default value group are, for example, the page size, the statistical range, and the capacity ratio. The “statistical range” is, as explained above, the number of pages corresponding to one statistical entry. The “capacity ratio” is the ratio of each media type in the pool. According to the example in FIG. 14B, the information below can be ascertained:

(a) 2/100 of the pool capacity is the total capacity of the plurality of pages based on SSD.

(b) 10/100 of the pool capacity is the total capacity of the plurality of pages based on SAS

(c) 88/100 of the pool capacity is the total capacity of the plurality of pages based on SATA.

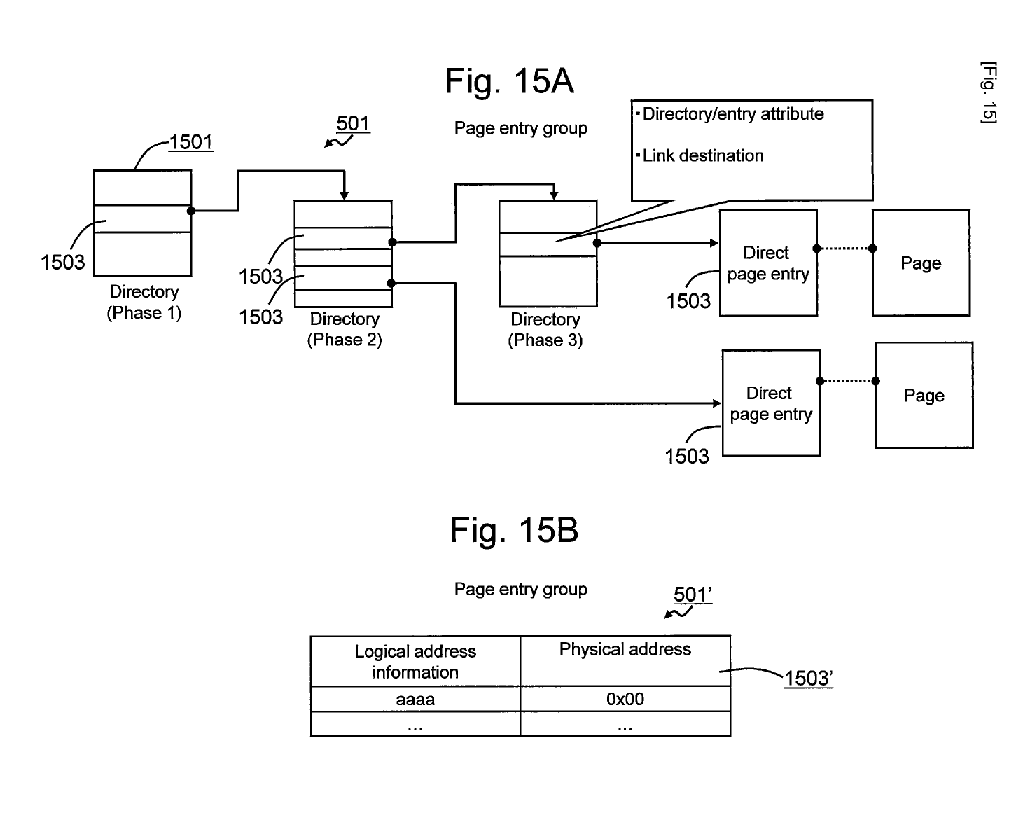

FIG. 15A shows the configuration of the page entry group 501.

The page entry group 501, for example, exists in each VVOL. The page entry group 501 shows the correspondence relationship between virtual areas and pages in the VVOL.

The page entry group 501 includes one or more directories 1501.

Each directory 1501 is configured of a plurality (e.g. a specified number) of directory page entries 1503. Each of the directory page entries 1503 is one of the plurality of types of entries 1503 described below:

(15A-1) a directory page entry 1503 which is directly associated with a directory 1501 on the next phase (closest and lower);

(15A-2) a direct page entry 1503 with which a direct page entry 1503 is associated; and

(15A-3) a directory page entry 1503 with which neither directory 1501 nor direct page entry 1503 is associated.

If receiving a write command in which a logical address (e.g. an LBA) in a VVOL is specified as a write destination from an external device (e.g. a host) 101, the controller performs the processing below:

(W1) referring to a directory page entry 1503 in the directory on the first phase corresponding to the specified logical address;

(W2) determining which type of page entry 1503 the directory page entry 1503 which is referred to is among the above-mentioned [types] from (15A-1) to (15A-3);

(W3) if determining at the above-mentioned (W2) that the directory page entry 1503 is the entry 1503 of the above-mentioned (15A-1), referring to the directory page entry 1503 corresponding to the specified logical address in the directory associated with the directory page entry 1503 which is referred to, and performing the above-mentioned (W2) again;

(W4) if determining at the above-mentioned (W2) that the directory page entry 1503 is the entry 1503 of the above-mentioned (15A-2), writing the write target data to the page corresponding to the direct page entry 1503 which is associated with the directory page entry 1503 which is referred to or;

(W5) if determining at the above-mentioned (W2) that the directory page entry 1503 is the entry 1503 of the above-mentioned (15A-3), acquiring a directory 1501 (a specified number of free directory page entries 1503) from the free page entry queue 1101A, associating the acquired directory 1501 with the directory page entry 1503 which is referred to, and performing the processing below,

(W5a) determining which should be associated with the directory page entry 1503 corresponding to the specified logical address in the associated directory 1501, the directory 1501 or the direct page entry 1503,

(W5b) if determining to associate the directory 1501 at the above-mentioned (W5a), acquiring the directory 1501 (a specified number of free directory page entries 1503) from the free page entry queue 1101A, associating the acquired directory 1501 with the directory page entry 1503 corresponding to the specified logical address (the directory page entry 1503 in the closest and higher directory 1501), and performing the above-mentioned (W5a) again,

(W5c) if determining to associate the direct page entry 1503 at the above-mentioned (W5a), selecting the direct page entry 1503 corresponding to the page to be assigned to the write destination virtual area (virtual area belonging to the logical address specified by the write command) from the free entry group 506, associating the selected direct page entry 1503 with the directory page entry 1503 corresponding to the specified logical address, and writing the write target data to the page corresponding to the direct page entry 1503.

The case where the directory 1501 is determined to be associated at the above-mentioned (W5a) is the case where more directories 1501 must be tracked for referring to the direct page entry 1503 corresponding to the page to be assigned. This case occurs if the page size is small considering the number of directories 1501 to be tracked.

Specifically speaking, the number of directories 1501 to be tracked until the direct page entry 1503 is identified depends on the page size corresponding to the direct page entry 1503. Specifically speaking, if the page size is large, the number of pages belonging to a certain logical address range is small, and therefore the number of directories 1501 to be tracked until the direct page entry 1503 is identified is small. Meanwhile, if the page size is small, the number of pages belonging to a certain logical address range is large, and therefore the number of directories 1501 to be tracked until the direct page entry 1503 is identified is large.

As described above, the page entry group 501 is in a tree structure, and each of the nodes in the tree is a directory 1501. The controller, each time receiving a write command, by tracking one or more directories 1501 in accordance with the logical address specified by the write command, identifies the page assigned to the write destination virtual area (virtual area belonging to the logical address specified by the write command), and writes the write target data to the page. If no page is assigned to the write destination virtual area, the controller adds a direct page entry 1503 from the free entry group 506 to the page entry group 501, and writes the write target data to the page corresponding to the direct page entry 1503. After one or more directories 1501 are added from the free entry group 506 to the page entry group 501 as needed, the direct page entry 1503 is added from the free entry group 506 to the page entry group 501.

Each directory page entry 1503 comprises directory/entry attribute information and link destination information. The directory/entry attribute information indicates whether the entry associated with the page entry 1503 comprising the information is a directory 1501 or a direct page entry. The link destination information indicates the ID of the directory 1501 associated with the page entry 1503 comprising the information or the address of the direct page entry. Specifically speaking, for the directory page entry 1503 with which the directory 1501 on the next phase is associated, as the directory/entry attribute information, the information indicating the directory is registered, and the ID of the directory 1501 on the next phase is registered as the link destination information. Meanwhile, for the directory page entry 1503 with which the direct page entry 1503 is associated, as the directory/entry attribute information, the information indicating the entry is registered, and the information indicating the address of the associated direct page entry 1503 is registered as the link destination information.

Each direct page entry 1503 comprises page address information. The page address information is the information indicating the address of the page corresponding to the direct page entry 1503 which comprises the information (physical address).

Furthermore, for example, assigning a series of directory page entries 1503 for a directory 1501 may be adopted. In this way, pointers to each directory page entry 1503 in the directory 1501 can be omitted, so memory consumption can be saved.

The configuration of the page entry group 501 is explained as above. It should be noted that the configuration of the page entry group 501 is not limited to the configuration shown in FIG. 15A. For example, as a page entry group (the information indicating the correspondence relationship between virtual areas and pages), a page entry group 501′ shown in FIG. 15B may also be adopted. This page entry group 501′ is configured of one or more direct page entries 1503′ and does not comprise a direct page entry. Therefore, if a page entry group 501′ shown in FIG. 15B is adopted, no direct page entry may be required. Each direct page entry 1503′ may comprise logical address information in addition to the page address. The logical address information is the information indicating the logical address and, for example, may be the hash value of a part or the entire logical address. The controller can identify the direct page entry 1503′ belonging to the logical address by utilizing the hash value of the logical address specified by the I/O command.

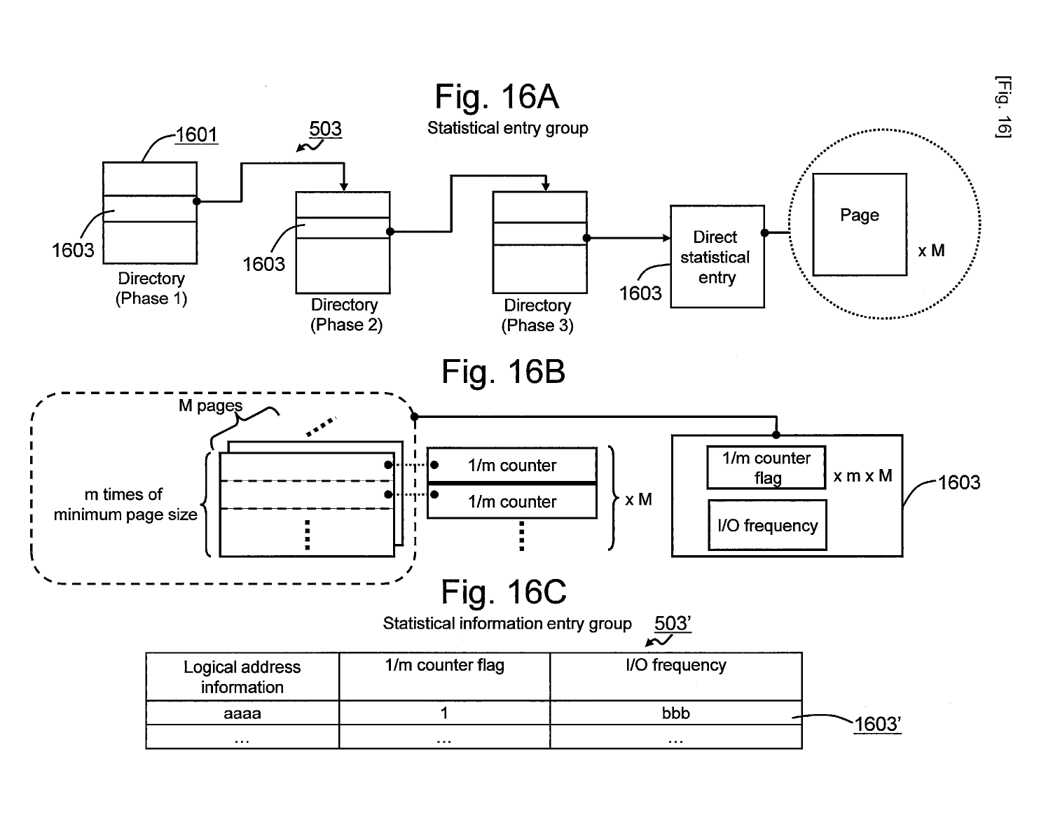

FIG. 16A shows the configuration of the statistical entry group 502.

The statistical entry group 502, for example, exists in each VVOL. The statistical entry group 502 comprises the statistical information of the pages assigned to the virtual area in the VVOL (e.g. the information indicating the I/O frequency).

The configuration of the statistical entry group 502 is practically the same as the configuration of the page entry group 501. Specifically speaking, the statistical entry group 502 includes one or more directories 1601. Each directory 1601 is configured of a plurality (e.g. a specified number) of directory statistical entries 1603. Each of the directory statistical entries 1603 is one of the plurality of types of entries 1603 described below:

(16A-1) a directory statistical entry 1603 which is directly associated with the closest and lower directory 1601;

(16A-2) a directory statistical entry 1603 with which a direct statistical entry 1603 is associated; and

(16A-3) a directory statistical entry 1603 with which neither directory 1601 nor direct statistical entry 1603 is associated.

The controller, if receiving a write command in which a logical address (e.g. an

LBA) in a VVOL is specified as a write destination from an external device (e.g. a host) 101, performs the above-mentioned processing from (W1) to (W5), in which case, the controller can add a directory 1601 from the free entry group 506 to the statistical entry group 502 and update the information which the direct statistical entry 1603 corresponding to the write destination page comprises.

The number of directories 1601 to be tracked until the direct statistical entry 1603 is identified depends on the page size corresponding to the direct statistical entry 1603 and the value M (the number of pages corresponding to the direct statistical entry 1603).

As described above, the statistical entry group 502 is in a tree structure, and each of the nodes in the tree is a directory 1601. The controller, each time receiving a write command, by tracking one or more directories 1601 in accordance with the logical address specified by the write command, can identify the direct statistical entry 1603 corresponding to the page assigned to the write destination virtual area (virtual area belonging to the logical address specified by the write command) and update the information which the entry 1603 comprises (e.g. the information indicating the I/O frequency). If no page is assigned to the write destination virtual area, the controller can add a direct statistical entry 1603 from the free entry group 506 to the statistical entry group 502 and update the information which the direct statistical entry 1603 comprises. After one or more directories 1601 are added from the free entry group 506 to the statistical entry group 502 as needed, the direct statistical entry 1603 may be added from the free entry group 506 to the statistical entry group 502.

Each directory statistical entry 1603 comprises directory/entry attribute information and link destination information. The directory/entry attribute information indicates whether the entry associated with the statistical entry 1603 comprising the information is a directory 1601 or a direct statistical entry. The link destination information indicates the ID of the directory 1601 associated with the statistical entry 1603 comprising the information or the address of the direct statistical entry. Specifically speaking, for the directory statistical entry 1603 with which the directory 1601 on the next phase is associated, as the directory/entry attribute information, the information indicating the directory is registered, and the ID of the directory 1601 on the next phase is registered as the link destination information. Meanwhile, for the directory statistical entry 1603 with which the direct statistical entry 1603 is associated, as the directory/entry attribute information, the information indicating the entry is registered, and the information indicating the address of the associated direct statistical entry 1603 is registered as the link destination information.

Each directory statistical entry 1603, as shown in FIG. 16B as an example, comprises a 1/m counter flag and an I/O frequency as information. The 1/m counter flag indicates whether any 1/m counters are assigned or not. If the 1/m counter flag shows the value “1,” [the entry] comprises m 1/m counters respectively corresponding to m pages areas.

The 1/m counters are assigned from a 1/m counter group 518 and collected to the 1/m counter group 518. The number of 1/m counters which the 1/m counter group 518 comprises may be determined in advance, for example. The number of 1/m counters does not have to depend on any of the page size per media type, the statistical range, or the capacity ratio. Specifically speaking, regardless of the page size per media type, the statistical range, or the capacity ratio, the number of 1/m counters may also be fixed. It may also be permitted that the total number of 1/m counters is fixed and that the total number is distributed to a plurality of types of media types by the ratio of the total number of pages per media type (except the highest tier as explained later).

The 1/m counter indicates the I/O frequency of a page area corresponding to the counter among m pages areas in the page. One 1/m counter may correspond to one page area only, or may also correspond to the respective page areas in M pages (specifically speaking, M page areas). The value M indicates the number of pages associated with one statistical entry.

If M pages are associated with one statistical entry, the I/O frequency in the statistical entry may be a value based on the I/O frequencies of the M pages (e.g. the sum or the average) associated with the statistical entry. If the 1/m counters correspond to all the page areas in the M pages, the I/O frequency may the value based on those 1/m counters (e.g. the sum or the average).

In this embodiment, the statistical entries do not have to comprise I/O frequencies (while the statistical entries must comprise I/O frequencies in the Embodiment 2). Furthermore, one statistical entry may comprise one 1/m counter flag (specifically speaking, there may be one 1/m counter flag for M pages), may also comprise m 1/m counter flags (specifically speaking, there may be m 1/m counter flags for M pages), or may also comprise (m×M) 1/m counter flags (specifically speaking, there may be a 1/m counter flag for each page area of each page of M pages).

Hereinafter, in this embodiment, for simplifying the explanation, it is assumed that there is a 1/m counter flag for each page area and, at the same time, that one 1/m counter is assigned to one page area.

Furthermore, for example, assigning a series of directory statistical entries 1603 for a directory 1601 may be adopted. In this way, pointers to each directory statistical entry 1603 in the directory 1601 can be omitted, so memory consumption can be saved.

The configuration of the statistical entry group 502 is explained as above. It should be noted that the configuration of the statistical entry group 502 is not limited to the configuration shown in FIG. 16A. For example, as a statistical entry group (the information indicating the statistical information for every M pages), a statistical entry group 502′ shown in FIG. 16C may also be adopted. This statistical entry group 502′ is configured of one or more direct statistical entries 1603′ and does not comprise a directory statistical entry. Therefore, if a statistical entry group 502′ shown in FIG. 16C is adopted, no directory statistical entry may be required. Each direct statistical entry 1603′ may comprise logical address information corresponding to M pages in addition to m 1/m counters for M pages and the I/O frequency information. The logical address information is the information indicating the logical address corresponding to M pages and, for example, may be the hash value of a part or the entire logical address. The controller can identify the direct statistical entry 1603′ belonging to the logical address by utilizing the hash value of the logical address specified by the I/O command. The logical address range corresponding to one direct statistical entry 1603′ depends on both the page size and the number of pages associated with the direct statistical entry 1603′.

In any of the statistical entry groups in the Figures from 16A to 16C, the 1/m counters may be associated by any of the methods described below.

(a) The 1/m counters are associated with statistical entries directly.

(b) The information indicating the correspondence relationship between the 1/m counters and logical address information is set separately.

Hereinafter, the processing performed in this embodiment is explained.

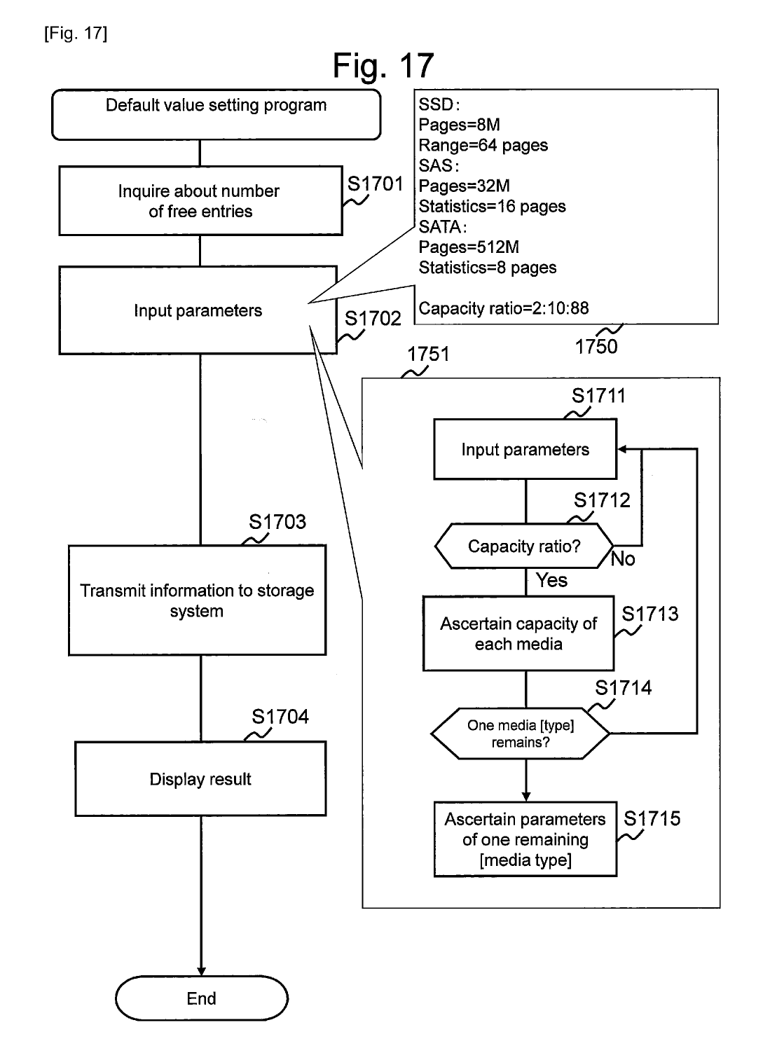

FIG. 17 shows the flow of the processing performed by the default value setting program 403.

The default value setting program 403, for each media type, sets the default values of a page size, a statistical range (the value M which is the number of pages which are associated with one statistical entry), and a capacity ratio in the storage system 103. In course of the setting, the default value setting program 403 reduces the load of inputting the page size and the statistical range (the load on the administrator).

(S1701)

The program 403 transmits a query about the number of free entries to the storage system 103. The program 403 receives a response to the query from the storage system 103, and writes the numeral value indicated by the response to the storage resource 153. The numeral values are the number of page entries 1503 and the number of statistical entries 1603 in the free entry group 506. As the number of page entries 1503, the number of directory page entries and the number of direct page entries may exist. As the number of statistical entries 1603, the number of directory statistical entries and the number of direct statistical entries may exist.

(S1702)

The program 403 accepts the input of various types of parameters from the administrator. Specifically speaking, for example, the processing described below is performed.

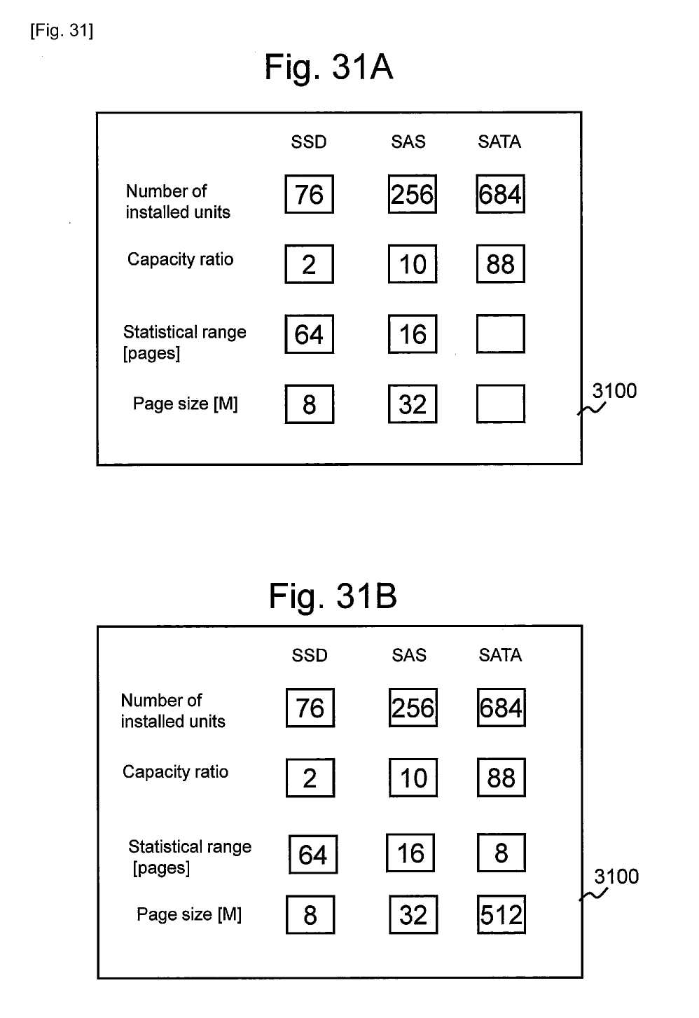

(S1711) The program 403 displays the default value input screen 3100 (refer to FIG. 31A) on the display device 159, and waits for the input to the input screen 3100. The parameter types which the input screen 3100 accepts are, for each of P media types (P indicates an integral number which is 2 or larger, P=3 in this embodiment), the number of installed units, the capacity ratio, the statistical range, and the page size exist. Input fields for various types of parameters are on the screen 3100. The various types of parameters are described below.

(Number of installed units) The number of installed units indicates the number of media. A plurality of values which can be input as the number of installed units are identified in advance by the program 403 in accordance with the RAID level of the RAID group and the number of media configuring the RAID group. The program 403 accepts the specification of the desired number of installed units from the plurality of values identified in advance as the number of installed units from the administrator. (Capacity ratio) The capacity ratio is a value indicating the occupied ratio to the entire pool as explained above. If the capacity ratios are input about (P−1) media types, the program 403 ascertains the capacity ratios of one remaining media type by the formula below,

100−(Total sum of capacity ratio of (P−1) units).

The program 403 displays the ascertained capacity ratio in the input field corresponding to the one remaining media type (the input field in the screen 3100).

(Statistical range) The statistical range is the number of pages associated with the statistical entry 1603 (the above-mentioned value M) as explained above.

(Page size) The page size is the size of the page as explained above. The unit is MB (megabyte), for example.

(S1712) The program 403 determines whether the capacity ratios are determined for all of the P media types or not. If the result of the determination is negative (S1712: No), the program 403 waits for the input of the capacity ratio (S1711). If the result of the determination is affirmative (S1712: Yes), S1713 is performed.

(S1713) In accordance with the number of installed units and the capacity ratio for each of the P media types, the program 403 ascertains the capacity of each of the media types in the pool. The capacity of a medium may be all the same per media type.

(S1714) The program 403 determines about the one remaining media type whether the statistical range and the page size are already input or not. If the result of the determination is negative (S1714: No), the program 403 waits for the input of the statistical range or the page size (S1711). If the result of the determination is affirmative (S1714: Yes), S1715 is performed.

(S1715) In accordance with the number of free entries answered at S1701 (the number of free page entries and the number of free statistical entries) and the page sizes and the statistical ranges which are already input for (P−1) media types, the program 403 ascertains the statistical range and the page size for the one remaining media type. The program 403 displays the ascertained statistical range and page size on the input field corresponding to the one remaining media type (input field on the input screen 3100) (refer to FIG. 31B).

(S1703)

The program 403 transmits a setting request of the default information including the various types of parameter values (the number of installed units, the capacity ratio, the statistical range, and the page size) which are determined (input) for all the P media types to the storage system 103. The default information may include the information indicating the capacities of various types of media ascertained at S1713. The controller of the storage system 103 can register the various types of parameters (default values) which the default information comprises in the default value table 512. The controller returns the result information indicating the result of receiving the default information (e.g. that the registration is successful) to the management apparatus 107.

(S1704)

The program 403 receives the result information for the transmission of the information at S1703 from the storage system 103, and displays the information complying with the result information on the display device 159.

According to the processing flow shown in FIG. 17, the administrator does not have to input parameters for all of the P media types. If the capacity ratios, the statistical ranges, and the page sizes are input for (P−1) media types, the program 403 ascertains the capacity ratio, the statistical range, and the page size for the one remaining media type, and displays each of the same.

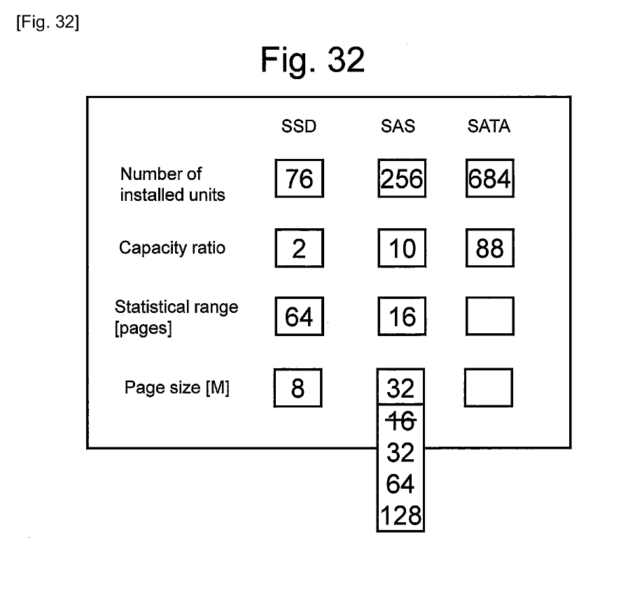

Furthermore, in this embodiment, as one method of parameter input support, in accordance with the number of free entries, the program 403 can inhibit the administrator inputting a numeral value which cannot be realized. For example, as shown in FIG. 32, in accordance with the number of free page entries and the page size(s) which is (are) already input for one or more media types, the program 403 can restrict the input of such page size that makes the number of free page entries insufficient being performed for the media types whose page sizes are not input yet. Specifically speaking, for example, as shown in FIG. 32, the program 403 displays the pull-down menu in the page size input field and, in the menu, among the plurality of page sizes, sets the page sizes which are small enough to make the number of free page entries insufficient to the non-enterable status. Specifically speaking, in this embodiment, the program 403 can control [the system] so that a page size (and a statistical range) which might make the page entries (and statistical entries) insufficient may not be set in the storage system 103 from the free entry group 506.

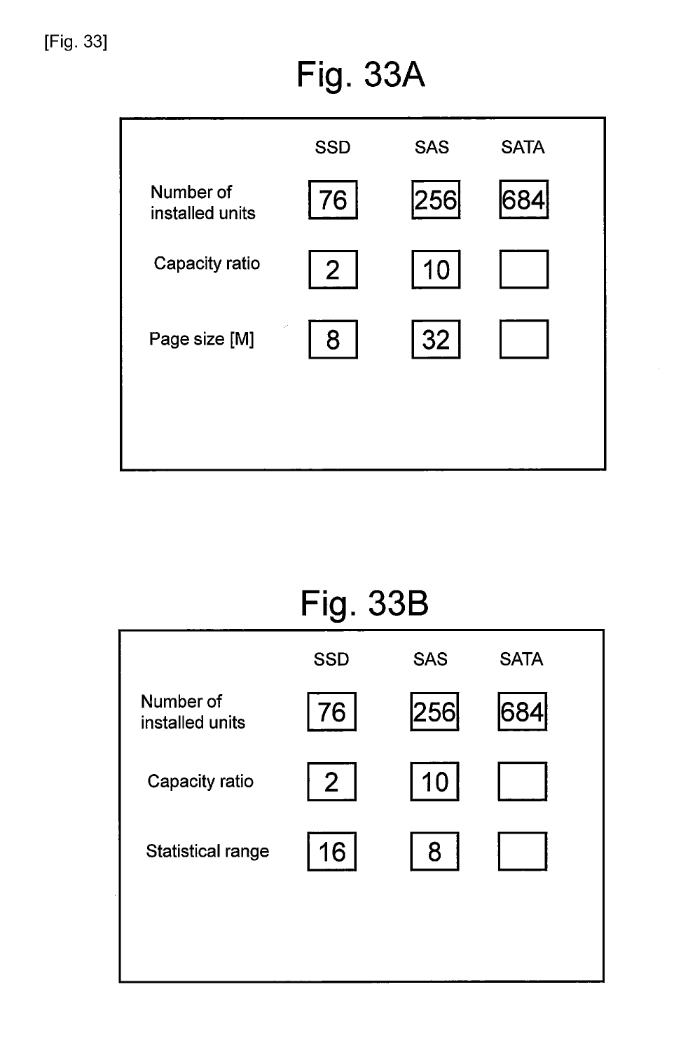

It should be noted that the page size is variable (a first characteristic) and, at the same time, that a plurality of pages can be associated with a statistical entry (a second characteristic) in this embodiment. Therefore, as a default value (parameter) which can be input to the default value input screen 3100, both the page size and the statistical range can be input (refer to FIG. 31A and FIG. 31B). In the case to which the first characteristic is applied but the second characteristic is not, the program 403 accepts the input of the page size, but does not have to accept the input of the statistical range (refer to FIG. 33A). Meanwhile, in the case to which the second characteristic is applied but the first characteristic is not, the program 403 accepts the input of the statistical range, but does not have to accept the input of the page size (refer to FIG. 33B).

Furthermore, in this embodiment, as explained below, various types of parameters may also be determined. It should be noted that “P” is the number of media types as explained above, which is 3 in this embodiment (SSD, SAS, and SATA).

(Ratio of Number of Slots)

The ratio of slots (connectors to which media are inserted) of various types of media. To the slots, any of SSD, SAS, and SATA [media] may be inserted. The ratio of number of slots per media type may be ascertained by the formula below,

(Ratio of number of slots in media type Y (Y is SSD, SAS, or SATA))=(Capacity ratio of Y/media size of Y)/(total sum of (capacity ratios/media sizes) for P media types).

The “media size” is the size of a medium. In this embodiment, the same size (capacity) of media may be installed for the same type of media.

### (Number of Slots in Each Type of Media)

The number of slots for the media type Y may be ascertained by the formula below,

(Number of slots for media type Y)=(Ratio of number of slots of Y)×(Total number of media slots).

The ascertained number of slots may also be rounded up (or truncated) to a multiple of a specified value (e.g. 4) to make it easy to configure a RAID group.

### (Capacity of Each Type of Media)

The capacity of the media type Y may be ascertained by the formula below,

(Capacity of media type Y)=(Number of slots of Y)×(Media size of Y).

The “media size” is the size of a medium.

(Number of entries corresponding to page parameter (e.g. page size or statistical range) corresponding to one remaining media type)

This number of entries is ascertained by the formula below,

(Number of entries corresponding to page parameter corresponding to one remaining media type)=(Number of free entries)−(Sum of number of entries corresponding to page parameters for (P−1) media types).

The sum of the number of entries corresponding to page parameters for (P−1) media types is the (media capacities/page parameters multipled by the number of entries needed to specify one page) for each of the (P−1) media types. The number of entries needed to specify one page depends on maximum depth of the directory 1501 or 1601, for example, in case the page parameter is page size and the maximum depth is 3, the number is sum of 3 for the directory page entries 1503 and 1 for the direct page entry 1503, that is 4.

(Page Parameter (e.g. Page Size or Statistical Range) Corresponding to One Remaining Media Type)

The page parameter corresponding to one remaining media type is ascertained by the formula below,

(Page parameter corresponding to one remaining media type)=(Media capacity corresponding to one remaining media type)/(Number of entries corresponding to page parameter corresponding to one remaining media type).

The ascertained value may be rounded up to a value (or a unit) which can be set such as the power of 2.

If the number of free entries is insufficient when the page parameters are input for (P−1) media types, the program 403 may display the information indicating the error on the display device 159 or, as explained above, may also restrict the input value so that such insufficiency will not occur from the beginning.

Furthermore, in this embodiment, size of a directory page entry 1503 and size of a direct page entry 1503 are identical, it may also be adopted to configure that each size is different, and the number of free entries for directory page entries 1503 and for direct page entries 1503 are managed separately, each number of entries corresponding to page parameter corresponding to one remaining media type for directory page entry 1503 and for direct page entry 1503 is calculated separately, in order to restrict the input value, the condition of the least free entries is selected. This may also applied for a directory statistical entry 1603 and a direct statistical entry 1603.

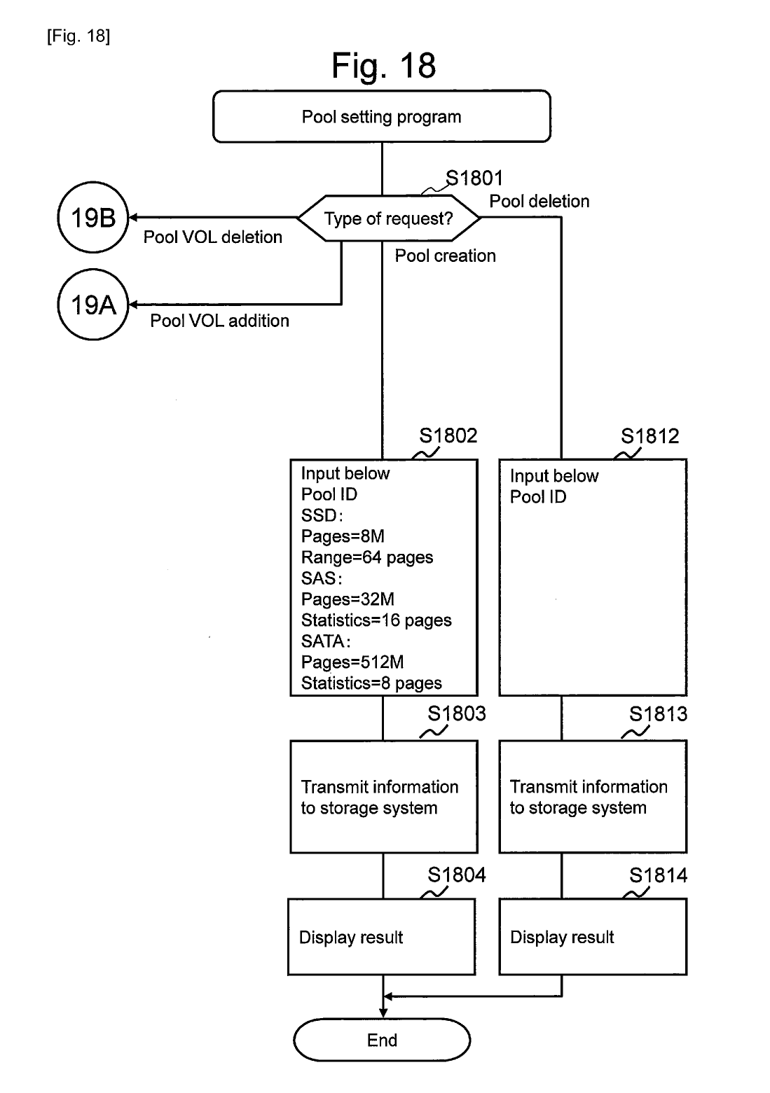

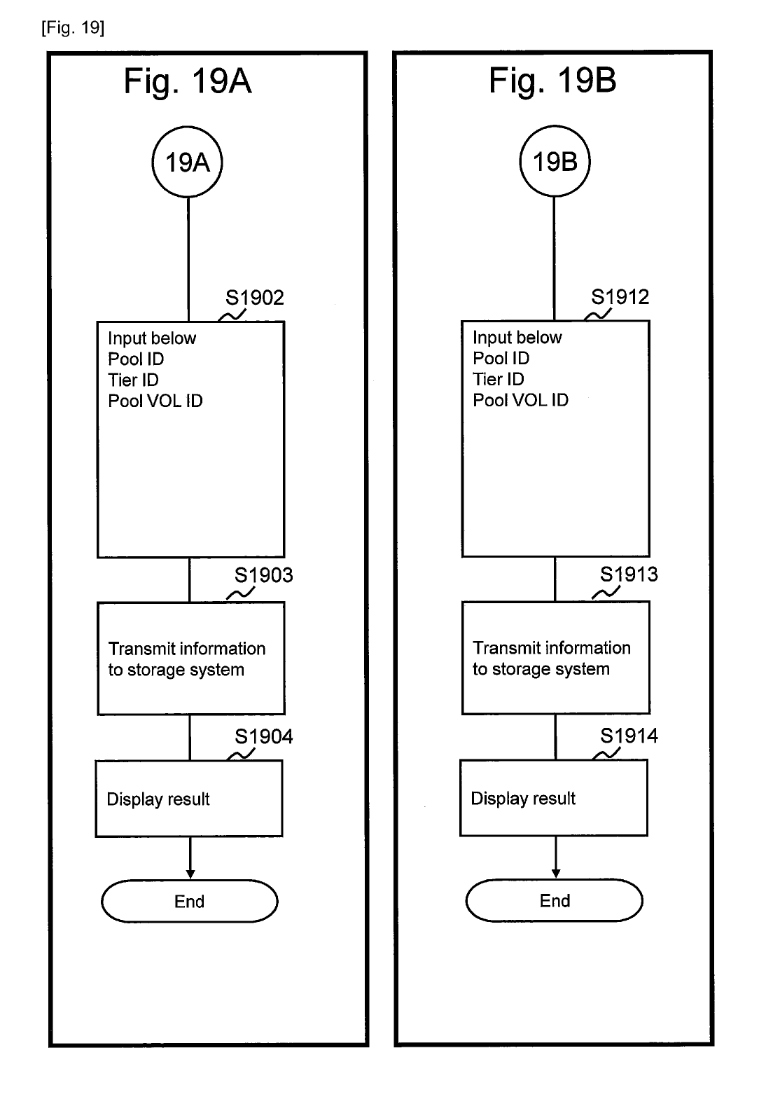

FIG. 18, FIG. 19A, and FIG. 19B show the flow of the processing performed by the pool setting program 401.

The pool setting program 401 sets the pool related information in the storage system 103.

(S1801)

The pool setting program 401 receives a request from the administrator via the input device 157, and determines the type of the request. If the request is a pool creation request, the processing from S1802 to S1804 is performed. If the request is a pool deletion request, the processing from S1812 to S1814 is performed. If the request is a pool VOL addition request, the processing from S1902 to S1904 is performed. If the request is a pool VOL deletion request, the processing from S1912 to S1914 is performed.

(S1802)

The program 401 accepts the input of a pool ID and a parameter group (various types of parameters for various media types (e.g. page sizes and statistical ranges)) via the input device 157. At this point, in response to the request from the administrator, the program 401 may also acquire a default value group which is already set in the storage system 103 (various types of parameters for the various media types (e.g. page sizes and statistical ranges)) from the storage system 103. The program 401 may also accept the information related to a plurality of tiers in the pool to be created (e.g. information indicating the media type and I/O frequency range of each of the tiers) via the input device 157.

(S1803)

The program 401 transmits a pool creation request including the pool ID and the parameter group to the storage system 103. The pool creation request may also include the above-mentioned information related to the plurality of tiers. The controller in the storage system 103 registers the pool ID and the parameter group. The controller may return the result information (e.g. the information indicating whether the registration is successful or not) to the management apparatus 107.

(S1804)

The program 401 displays the information indicating the result of S1803 (e.g. the result information from the storage system 103) on the display device 159.

(S1812)

The program 401 accepts the input of a pool ID via the input device 157.

(S1813)

The program 401 transmits a pool deletion request including the input pool ID to the storage system 103. The controller in the storage system 103 deletes the information related to the pool corresponding to the pool ID. The controller may return the result information (e.g. the information indicating whether the deletion is successful or not) to the management apparatus 107.

(S1814)

The program 401 displays the information indicating the result of S1813 (e.g. the result information from the storage system 103) on the display device 159.

(S1902)

The program 401 accepts the input of a pool ID, a tier ID, and a pool VOL ID via the input device 157.

(S1903)

The program 401 transmits a pool VOL addition request including the input pool ID, tier ID, and pool VOL ID to the storage system 103. The controller in the storage system 103 adds a VOL corresponding to the input pool VOL ID to the tier corresponding to the input pool ID and tier ID. The controller may return the result information (e.g. the information indicating whether the VOL addition is successful or not) to the management apparatus 107.

(S1904)

The program 401 displays the information indicating the result of S1903 (e.g. the result information from the storage system 103) on the display device 159.

(S1912)

The program 401 accepts the input of a pool ID, a tier ID, and a pool VOL ID via the input device 157.

(S1913)

The program 401 transmits a pool VOL deletion request including the input pool ID, tier ID, and pool VOL ID to the storage system 103. The controller in the storage system 103 deletes the VOL corresponding to the pool VOL ID from the tier corresponding to the pool ID and the tier ID. The controller may return the result information (e.g. the information indicating whether the deletion is successful or not) to the management apparatus 107.

(S1914)

The program 401 displays the information indicating the result of S1913 (e.g. the result information from the storage system 103) on the display device 159.

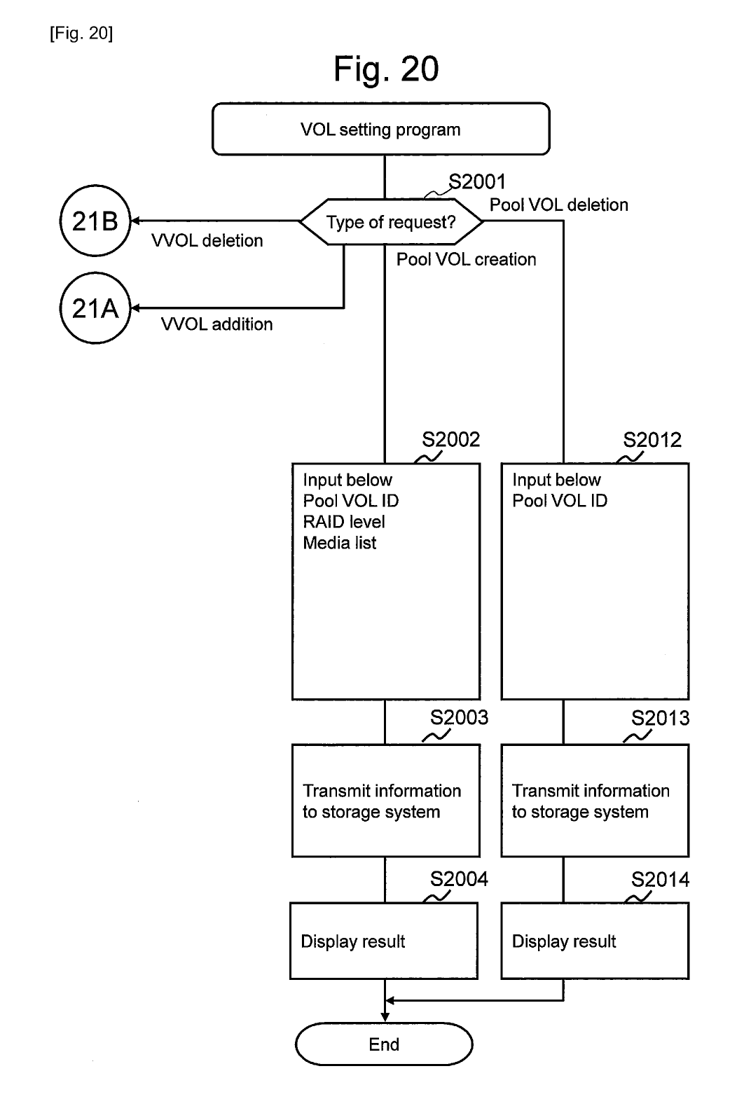

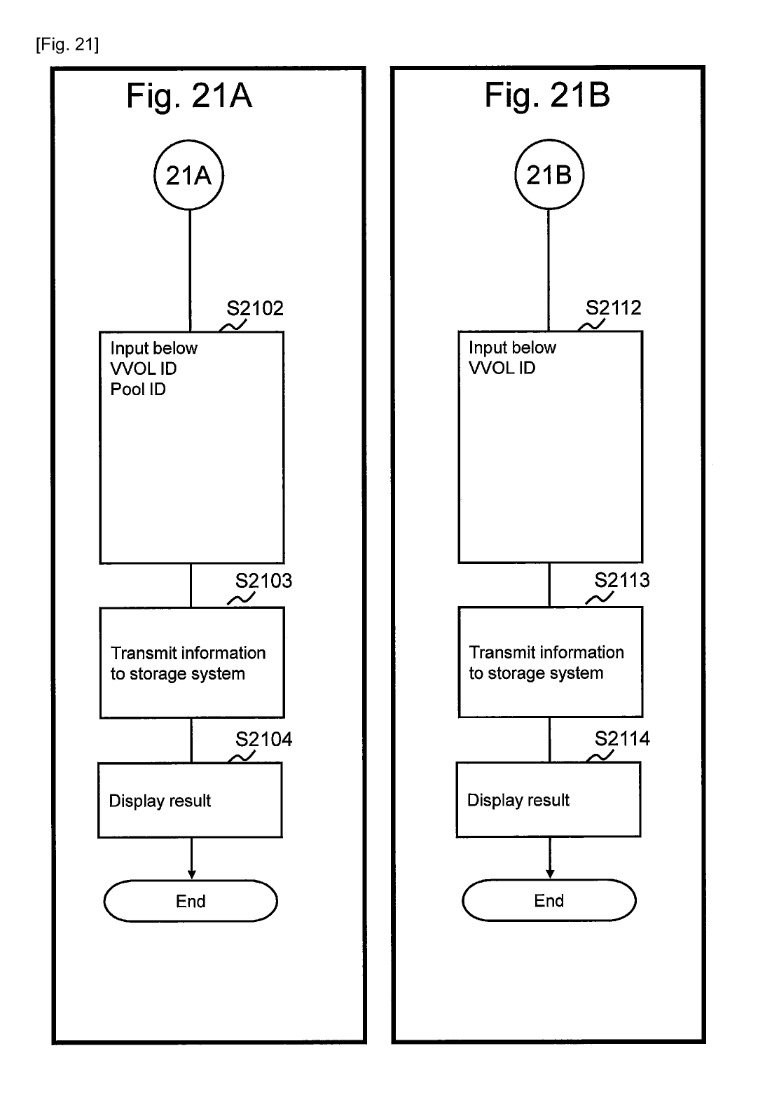

FIG. 20, FIG. 21A, and FIG. 21B show the flow of the processing performed by the VOL setting program 402.

The VOL setting program 402 sets the VOL related information in the storage system 103.

(S2001)

The VOL setting program 402 receives a request from the administrator via the input device 157, and determines the type of the request. If the request is a pool VOL creation request, the processing from S2002 to S2004 is performed. If the request is a pool VOL deletion request, the processing from S2012 to S2014 is performed. If the request is a VVOL addition request, the processing from S2102 to S2104 is performed. If the request is a VVOL deletion request, the processing from S2112 to S2114 is performed.

(S2002)

The program 402 accepts the input of a pool VOL ID, a RAID level, and a media list via the input device 157.

(S2003)

The program 402 transmits a pool VOL creation request including the input pool VOL ID, RAID level and media list to the storage system 103. The controller in the storage system 103 creates a VOL based on the RAID group complying with the RAID level and the media list as a pool VOL of the pool VOL ID. The controller may return the result information (e.g. the information indicating whether the pool VOL creation is successful or not) to the management apparatus 107.

(S2004)

The program 402 displays the information indicating the result of S2003 (e.g. the result information from the storage system 103) on the display device 159.

(S2012)

The program 402 accepts the input of a pool VOL ID via the input device 157.

(S2013)

The program 402 transmits a pool VOL deletion request including the input pool VOL ID to the storage system 103. The controller in the storage system 103 deletes the pool VOL corresponding to the pool VOL ID from the pool. The controller may return the result information (e.g. the information indicating whether the deletion is successful or not) to the management apparatus 107.

(S2014)

The program 402 displays the information indicating the result of S2013 (e.g. the result information from the storage system 103) on the display device 159.

(S2102)

The program 402 accepts the input of a VVOL ID and a pool ID via the input device 157.

(S2103)

The program 402 transmits a VVOL addition request including the input VVOL ID and pool ID to the storage system 103. The controller in the storage system 103 adds a VVOL corresponding to the input VVOL ID, and associates the VVOL with the pool corresponding to the input pool ID. The controller may return the result information (e.g. the information indicating whether the VVOL addition is successful or not) to the management apparatus 107.

(S2104)

The program 402 displays the information indicating the result of S2103 (e.g. the result information from the storage system 103) on the display device 159.

(S2112)

The program 402 accepts the input of a VVOL ID via the input device 157.

(S2113)

The program 402 transmits a VVOL deletion request including the input VVOL ID to the storage system 103. The controller in the storage system 103 deletes the information corresponding to the VVOL ID. The controller may return the result information (e.g. the information indicating whether the deletion is successful or not) to the management apparatus 107.

(S2114)

The program 402 displays the information indicating the result of S2113 (e.g. the result information from the storage system 103) on the display device 159.

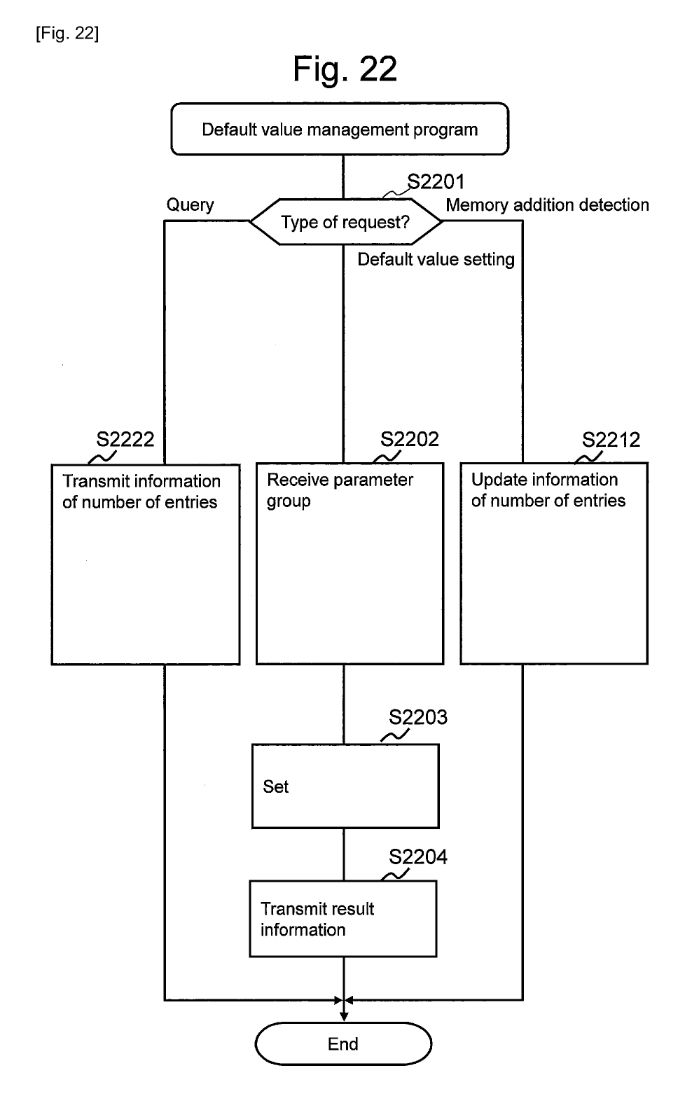

FIG. 22 shows the flow of the processing performed by the default value management program 517.

The default value management program 517 performs the setting of default values, response, and others in accordance with requests.

(S2201)

The default value management program 517 receives a request and determines the type of the request. If the request is a query from the management apparatus 107 (a query issued at S1701 in FIG. 17), S2222 is performed. If the request is a default value setting request from the management apparatus 107 (a request issued at S1703), the processing from S2202 to S2204 is performed. If the request is a memory addition detection, S2212 is performed.

(S2202)

The program 517 receives the default information complying with the setting request, and registers various types of default values about the each of the media types which the information indicates in the default value table 512 (refer to FIG. 14B).

(S2203)

The program 517 transmits the result information (e.g. the information indicating whether the registration of the default values is successful or not) to the management apparatus 107.

(S2212)

If detecting that a memory is added (e.g. if a memory is added to the CMPK 119 or if a CMPK 119 is added), the program 517 adds page entries 1503 and/or statistical entries 1603 to the free entry group 506 and, at the same time, updates the free entry management table 511 (refer to FIG. 14A). The number of added page entries 1503 and/or statistical entries 1603 may be the number complying with a specified rule, for example, (capacity of added memory)/(size of one entry). The page entries and the statistical entries may be of the same size or may also be of different sizes. If the page entries and the statistical entries are of different sizes, the capacity to be used for the page entries in the added memory capacity may be (added memory capacity)×(size of page entry)/(size of page entry+size of statistical entry), and the capacity to be used for the statistical entries in the added memory capacity may be (added memory capacity)−(capacity used for the page entries).

(S2222)

The program 517, in response to the query, returns the number of free entries (the number of page entries and the number of statistical entries) indicated by the information 1401 and 1402 registered in the free entry management table 511 to the management apparatus 107. It should be noted that the number of directory page entries and the number of direct page entries may also be registered separately in the free entry management table 511. Similarly, the number of directory statistical entries and the number of direct statistical entries may also be registered separately in the free entry management table 511.

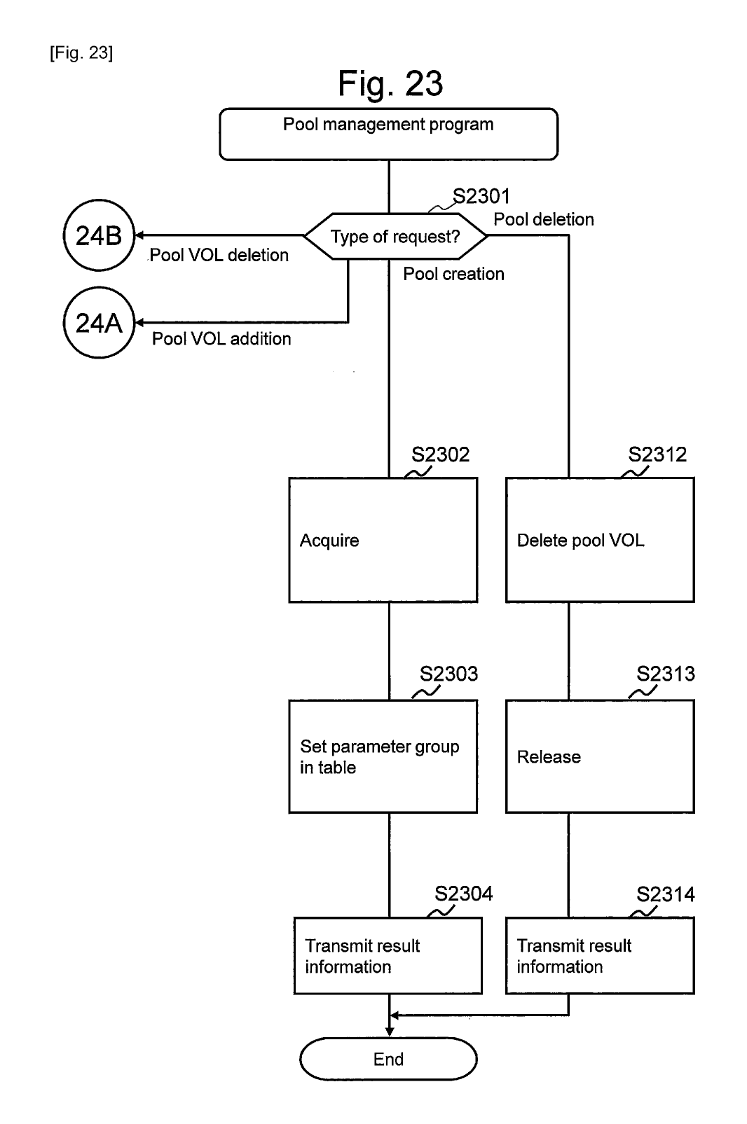

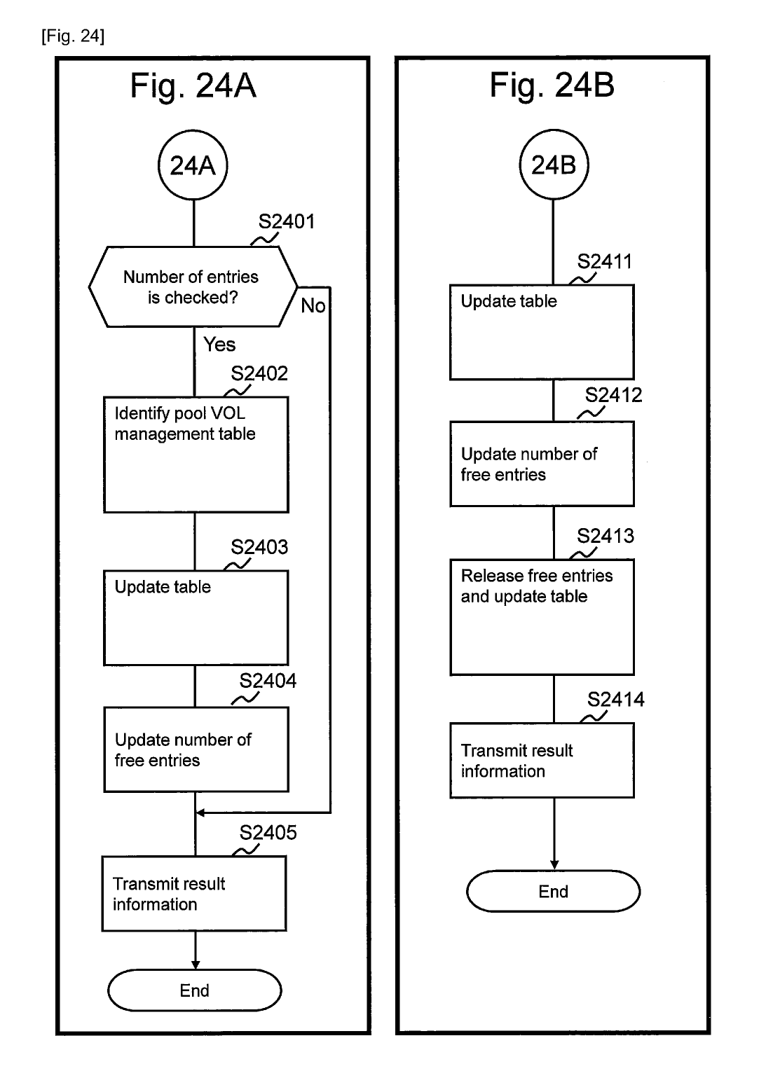

FIG. 23, FIG. 24A, and FIG. 24B show the flow of the processing performed by the pool management program 514.

The pool management program 514 performs the creation and deletion of pools and the addition and deletion of pool VOLs.

(S2301)

The pool management program 514 receives a request and determines the type of the request. If the request is a pool creation request (a request issued at S1803), the processing from S2302 to S2304 is performed. If the request is a pool deletion request (a request issued at S1813), the processing from S2312 to S2314 is performed. If the request is a pool VOL addition request (a request issued at S1903), the processing from S2401 to S2405 is performed. If the request is a pool VOL deletion request (a request issued at S1913), the processing from S2411 to S2414 is performed.

(S2302)

The program 514 obtains a blank row in the pool management table 503 and, at the same time, prepares a blank media setting value table 507 for each of the tiers identified by the pool creation request.

(S2303)

The program 514 registers a parameter group corresponding to each of the tiers identified by the pool creation request in each of the tables 507 prepared at S2302. Furthermore, the program 514 associates each of the tables 507 with the row obtained at S2302 (row in the pool management table 503) for each tier. It should be noted that, if the parameter group is a default value group, the pool creation request may also include the information indicating the use of the default value group instead of the parameter group. If identifying the information indicating the use of the default value group from the pool creation request, the program 514 may copy the group of values registered in the row of the default value table 512 to the media setting value table 507.

(S2304)

The program 514 transmits the result information (e.g. the information indicating whether the processing of the S2302 and S2303 is successful or not) to the management apparatus 107.

(S2312)

The program 514 performs the processing from S2411 to S2414 for all the pool VOLs included in the pool identified by the pool deletion request.

(S2313)

The program 514 releases the row corresponding to the pool identified by the pool deletion request from the pool management table 503 and, at the same time, releases a plurality of media setting value tables 507 associated with the row.

(S2314)

The program 514 transmits the result information (e.g. the information indicating whether the processing of the S2312 and S2313 is successful or not) to the management apparatus 107.

(S2401)

The program 514, in accordance with the capacity of the pool VOL identified by the pool VOL addition request and the parameter group (the page size and the statistical range) in the media setting value table 507 corresponding to the pool and the tier identified by the pool VOL addition request, ascertains the number of page entries and the number of statistical entries which are necessary for the pool VOL to be added. The program 514 determines whether the ascertained number of page entries and number of statistical entries are within the respective values which the page [entries] 1401 and the statistical [entries] 1402 (refer to FIG. 14A) indicate (the number of free page entries and the number of free statistical entries) or not. If the result of the determination is affirmative (S2401: Yes), the processing from S2402 to S2405 is performed. If the result of the determination is negative (S2401: No), instead of the processing from S2401 to S2404, S2405 is performed (e.g. the result information indicating the error is transmitted to the management apparatus 107).

(S2402)

The program 514 identifies a pool VOL management table 505 corresponding to the pool and the tier identified by the pool VOL addition request.

(S2403)

The program 514 adds the ID of the pool VOL which the pool VOL addition request comprises to the list 802 in the table 505 identified at S2402.

(S2404)

The program 514 subtracts the number of page entries and the number of statistical entries ascertained at S2401 from the page [entries] 1401 and the statistical [entries] 1402 (refer to FIG. 14A).

(S2405)

The program 514 transmits the result information (e.g. the information indicating whether the processing from 2401 to S2404 is successful or not) to the management apparatus 107.

(S2411)

The program 514 identifies the pool VOL management table 505 corresponding to the pool and the tier identified by the pool VOL deletion request, and deletes the ID of the pool VOL which the pool VOL deletion request comprises from the list 802 of the table 505.

(S2412)

The program 514, in accordance with the capacity of the pool VOL identified by the pool VOL deletion request and the parameter group (the page size and the statistical range) in the media setting value table 507 corresponding to the pool and the tier identified by the pool VOL deletion request, ascertains the number of page entries and the number of statistical entries which are necessary for the pool VOL to be deleted. The program 514 adds the ascertained number of page entries and number of statistical entries to the page [entries] 1401 and the statistical [entries] 1402 (refer to FIG. 14A).

(S2413)

If no pool VOL ID exists in the list 802 from which the pool VOL ID is deleted at S2411, the program 514 deletes the table 505 comprising the list 802.

(S2414)

The program 514 transmits the result information (e.g. the information indicating whether the processing from S2411 to S2413 is successful or not) to the management apparatus 107.

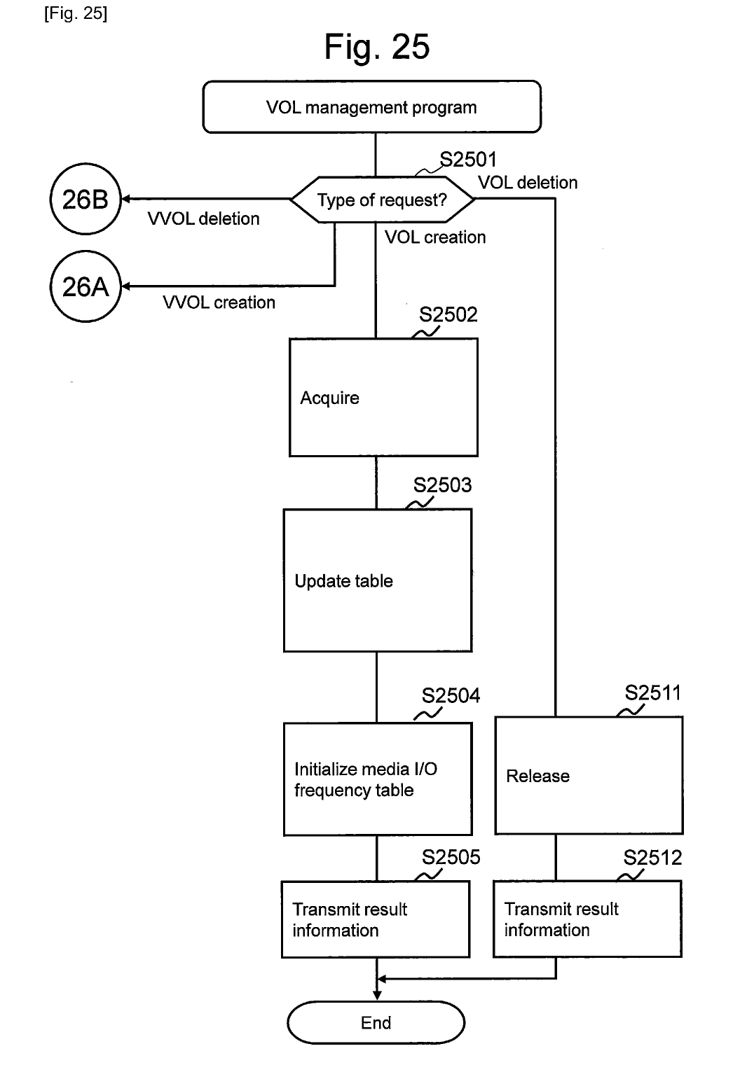

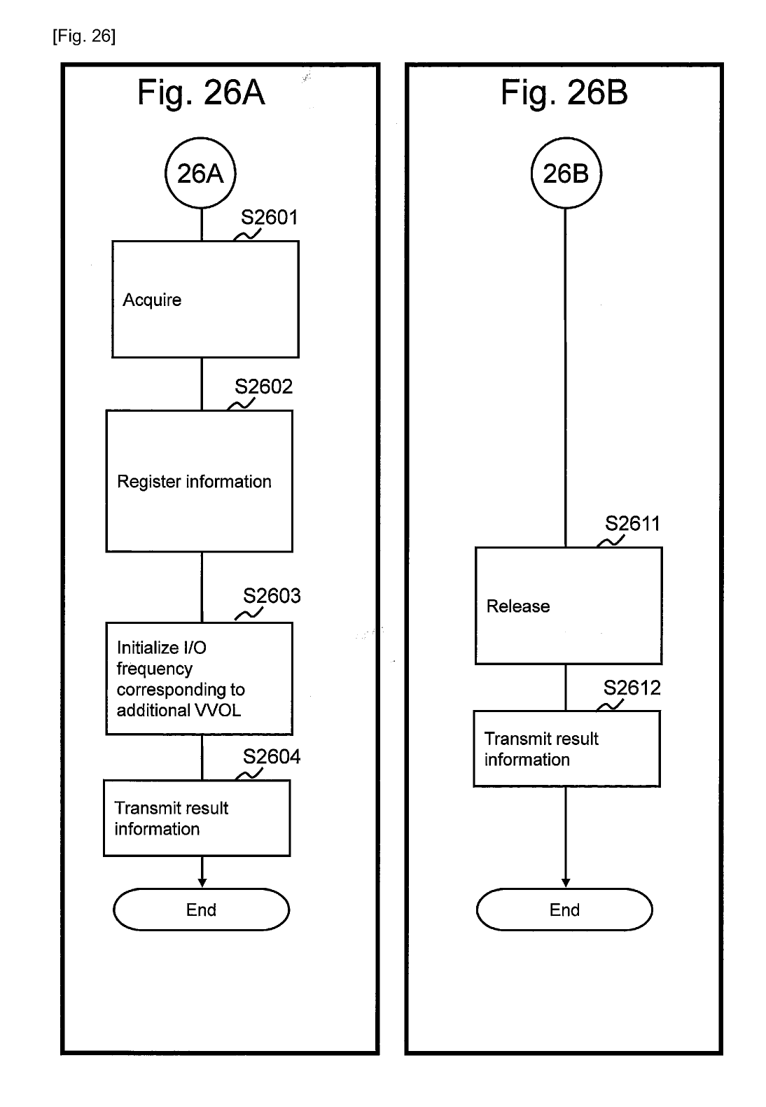

FIG. 25, FIG. 26A, and FIG. 26B show the flow of the processing performed by the VOL management program 515. The VOL management program 515 performs the creation and deletion of VOLs and the addition and deletion of VVOLs.

(S2501)

The VOL management program 515 receives a request and determines the type of the request. If the request is a pool VOL creation request (request issued at S2004), the processing from S2502 to S2505 is performed. If the request is a pool VOL deletion request (request issued at S2013), the processing of S2511 and S2512 is performed. If the request is a VVOL addition request (request issued at S2103), the processing from S2601 to S2604 is performed. If the request is a VVOL deletion request (request issued at S2113), the processing of S2611 and S2612 is performed.

(S2502)

The program 515 obtains a blank row in the VOL management table 508.

(S2503)

The program 515 identifies a RAID group relevant to the RAID level and the media list identified by the pool VOL creation request, creates a VOL complying with the RAID group, and registers the information in the row obtained at S2502. The registered information may be, for example, the ID of the created VOL (the pool VOL ID which the pool VOL creation request comprises), the type of the VOL, the ID of the RAID group for which the VOL is created, the media type of the RAID group, and the media list which the pool VOL creation request comprises.

(S2504)

The program 515 initializes the I/O frequency 1202 (refer to FIG. 12) of each of the media identified by the media list which the pool VOL creation request comprises.

(S2505)

The program 515 transmits the result information (e.g. the information indicating whether the processing from S2502 to S2505 is successful or not) to the management apparatus 107.

(S2511)

The program 515 releases the row corresponding to the VOL identified by the pool VOL deletion request from the VOL management table 508.

(S2512)

The program 515 transmits the result information (e.g. the information indicating whether the processing at S2511 is successful or not) to the management apparatus 107.

(S2601)

The program 515 obtains a blank row in the VOL management table 508.

(S2602)

The program 515 registers the information in the row obtained at S2601. The registered information may be, for example, the VVOL ID which the VVOL creation request comprises and the type of the VVOL (TP-VOL). Furthermore, with the VVOL corresponding to the VVOL ID which the VVOL creation request comprises (“additional VVOL” in FIG. 26A), the program 515 associates the pool corresponding to the pool ID which the request comprises.

(S2603)

The program 515 initializes the I/O frequency 1106 (refer to FIG. 10) corresponding to the additional VVOL.

(S2604)

The program 515 transmits the result information (e.g. the information indicating whether the processing from S2601 to S2603 is successful or not) to the management apparatus 107.

(S2611)

The program 515 releases the row corresponding to the VVOL identified by the VVOL deletion request from the VOL management table 508.

(S2612)

The program 515 transmits the result information (e.g. the information indicating whether the processing at S2611 is successful or not) to the management apparatus 107.

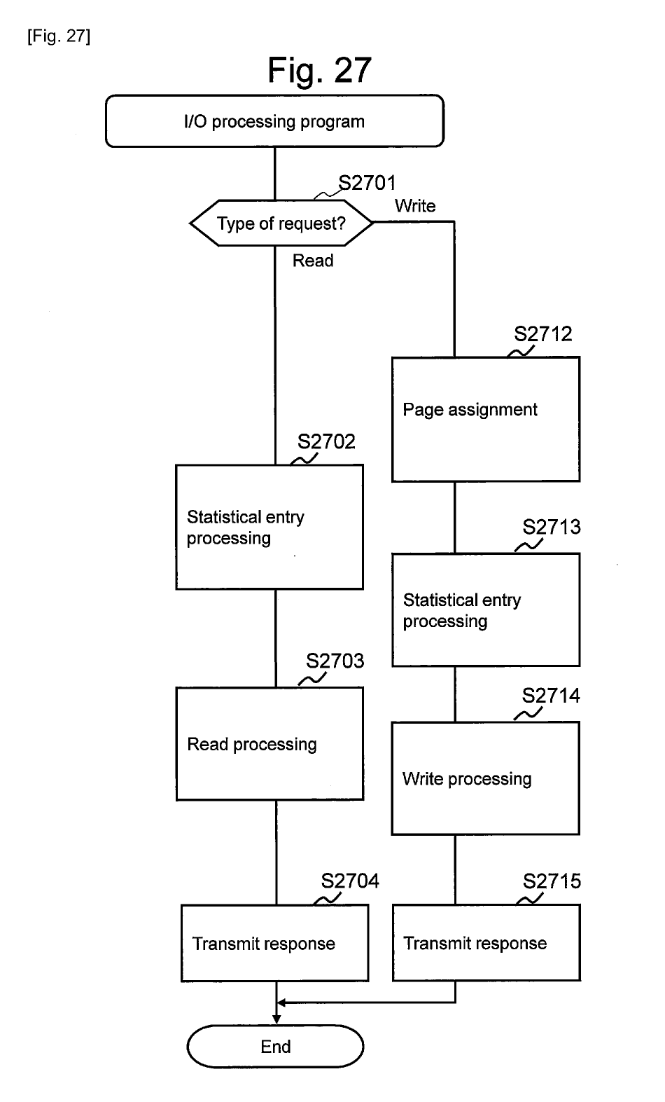

FIG. 27 shows the flow of the processing performed by the I/O processing program S13

The I/O processing program 513 processes I/O commands from the external devices 101.

(S2701)

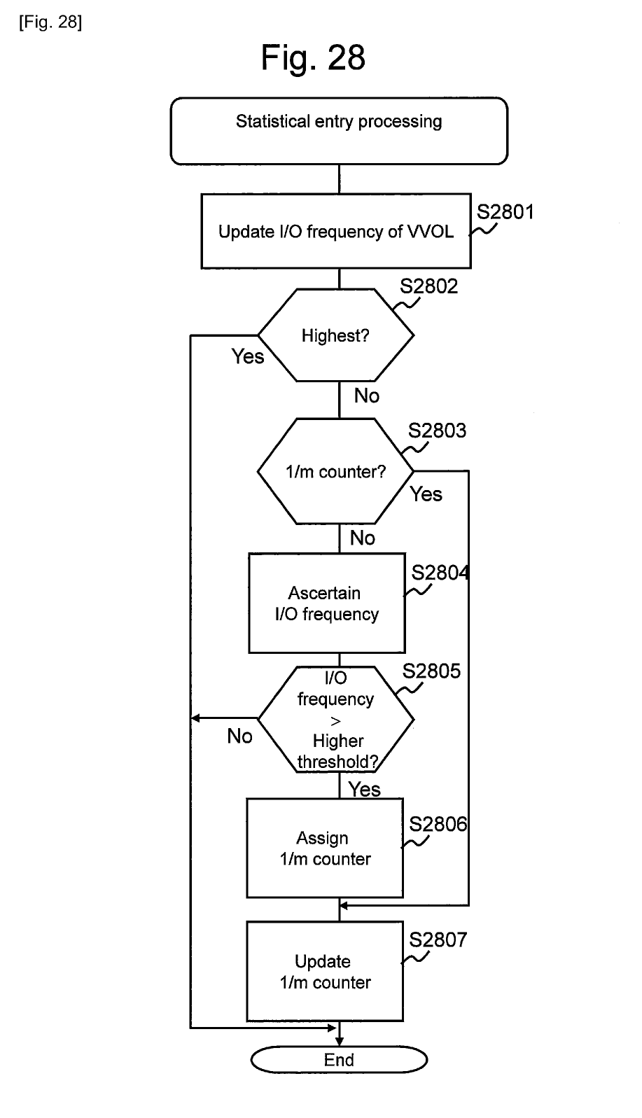

The I/O processing program 513 determines whether an I/O command is a write command or a read command from the external devices 101. If the I/O command is determined to be a read command, the processing from S2702 to S2704 is performed. If the I/O command is determined to be a write command, the processing from S2712 to S2715 is performed. In the explanation of FIG. 27 and FIG. 28, a logical address specified by an I/O command is referred to as an “I/O address,” a logical address specified by a read command is referred to as a “read address,” and a logical address specified by a write command is referred to as a “write address.”

(S2702)

The program 513 performs the statistical entry processing (refer to FIG. 28). In this statistical entry processing, the program 513 updates the I/O frequency in the statistical entry corresponding to a read address. The I/O frequency to be updated is the I/O frequency (e.g. a 1/m counter and/or the I/O frequency corresponding to the entire page) corresponding to the page assigned to a virtual area belonging to the read address (or the page area including the read target data which is read from the page).

(S2703)

The program 513 performs the read processing. In this read processing, the program S13 identifies the page assigned to the virtual area belonging to the read address by referring to the page entry group 501. The program 513 reads the read target data from the page area corresponding to the read address in the identified page. The data which is read is stored in the CMPK 119.

(S2704)

The program 513 transmits the read target data in the CMPK 119 to the external device 101.

(S2712)

In accordance with the page entry group 501, the program 513 determines whether a page is assigned to the virtual area belonging to the write address or not. If the result of the determination is negative, the program 513 performs the page assignment processing. In the page assignment processing, the program 513 assigns a page to the virtual area belonging to the write address. The page is assigned from any of the tiers in the pool associated with the VVOL including the virtual area. The tier which is the page assignment source may be the tier complying with a specified rule (e.g. a tier is determined in advance, a tier randomly determined, or a tier whose ratio of free pages is the highest in the pool). The concrete processing performed in the page assignment processing is described below, for example. Specifically speaking, the program 513 adds a direct page entry 1503 from the free entry group 506 to the page entry group 501. In some cases, the program 513 adds one or more directories 1601 from the free entry group 506 to the page entry group 501, and subsequently adds a direct page entry 1503 from the free entry group 506 to the page entry group 501. The direct page entry 1503 is associated with the last directory page entry 1503 corresponding to the write address.

(S2713)

The program 513 performs the statistical entry processing (refer to FIG. 28). In this statistical entry processing, the program 513 updates the I/O frequency in the statistical entry corresponding to the write address. The I/O frequency to be updated is the I/O frequency (e.g. a 1/m counter and/or the I/O frequency corresponding to the entire page) corresponding to the page assigned to a virtual area belonging to the write address (or the page area to be the write destination of the write target data).

(S2714)

The program 513 performs the write processing. In this write processing, the program 513 writes the write target data to the page assigned to the virtual area belonging to the write address. The write target data is temporarily stored in the CMPK 119, and the write target data is written from the CMPK 119 to the page.

(S2715)

The program 513 transmits a response to the write command (e.g. that the write processing is completed) to the external device 101. It should be noted that the response may also be transmitted to the external device 101 when the write target data is written to the CMPK 119.

FIG. 28 shows the flow of the statistical entry processing (S2702 or S2713 in FIG. 27).

(S2801)

The program 513 updates the I/O frequency 1106 (refer to FIG. 10) corresponding to the I/O destination VVOL (VVOL specified by the I/O command).

(S2802)

The program 513 determines whether the tier to which the I/O destination page (read source page or write destination page) belongs is the highest tier in the pool or not. If the result of the determination is negative (S2802: No), S2803 is performed. If the result of the determination is affirmative (S2802: Yes), the processing is terminated. This is because, as the size of the page belonging to the highest tier is the smallest page size in this embodiment, no 1/m counter for the page belonging to the highest tier exists.

(S2803)

The program 513 determines whether the 1/m counter flag corresponding to the I/O destination page area is “1” or not in the statistical entry corresponding to the I/O address (the statistical entry in the statistical entry group 502). If the result of the determination is affirmative (S2803: Yes), instead of the processing from S2804 to S2806, S2807 is performed. If the result of the determination is negative (S2803: No), S2804 is performed. It should be noted that the I/O destination page area is the area in the I/O destination page complying with the size of the I/O destination page and the I/O address.

(S2804)

The program 513 ascertains the I/O frequency corresponding to the I/O destination page area. Specifically speaking, for example, the program 513 ascertains the I/O frequency corresponding to the I/O destination page area by dividing the I/O frequency 1106 corresponding to the VVOL in the I/O destination (the I/O frequency updated at S2801) by the capacity of the VVOL.

(S2805)

The program 513 determines whether the I/O frequency ascertained at S2804 exceeds the higher threshold for the tier to which the I/O destination page belongs or not. If the result of the determination is affirmative (S2805: Yes), S2806 is performed. If the result of the determination is negative (S2805: No), the processing is terminated. It should be noted that there is one I/O frequency threshold for each of the highest tier and the lowest tier while a higher threshold and a lower threshold exist for a tier in this embodiment.

(S2806)

The program 513 assigns a 1/m counter to the I/O destination page area from the 1/m counter group 518. The m at this point indicates a value ascertained by dividing the size of the page as the I/O destination by the smallest page size. In the 1/m counter group 518, for each 1/m counter, the status indicating whether [the counter is] already assigned or unassigned may also be associated. This makes it possible to identify an unassigned 1/m counter (1/m counter not assigned to any of the page areas) from the 1/m counter group 518. It should be noted that, if no unassigned 1/m counter exists at this S2806, the program 513 may identify the page area with the smallest I/O frequency of the plurality of page areas to which the plurality of 1/m counters are respectively assigned, collect the 1/m counter assigned to the page area (make the same unassigned), and assign the 1/m counter to the I/O destination page. If no unassigned 1/m counter exists when assigning a 1/m counter, one 1/m counter may be collected and a plurality of 1/m counters may also be collected. Furthermore, the collected 1/m counter may also be the counter upated at the earliest point of time among the plurality of assigned 1/m counters.

(S2807)

The program 513 updates the 1/m counter corresponding to the I/O destination page area.

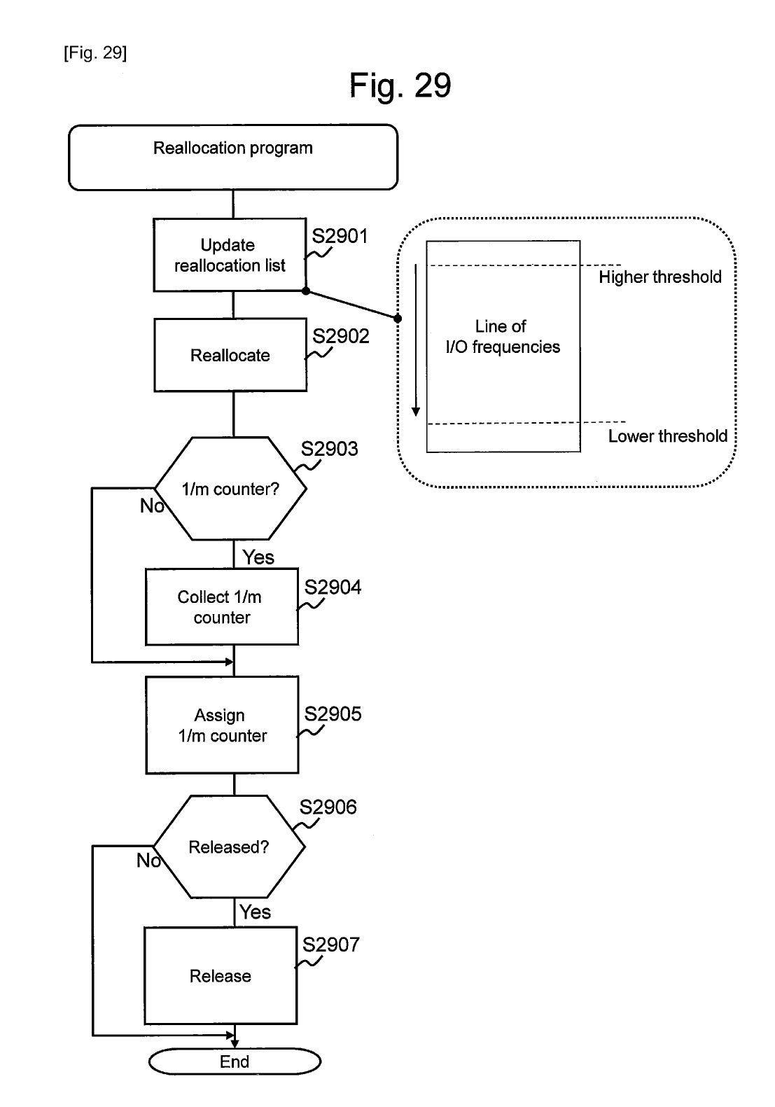

FIG. 29 shows the flow of the processing performed by the reallocation program 516.

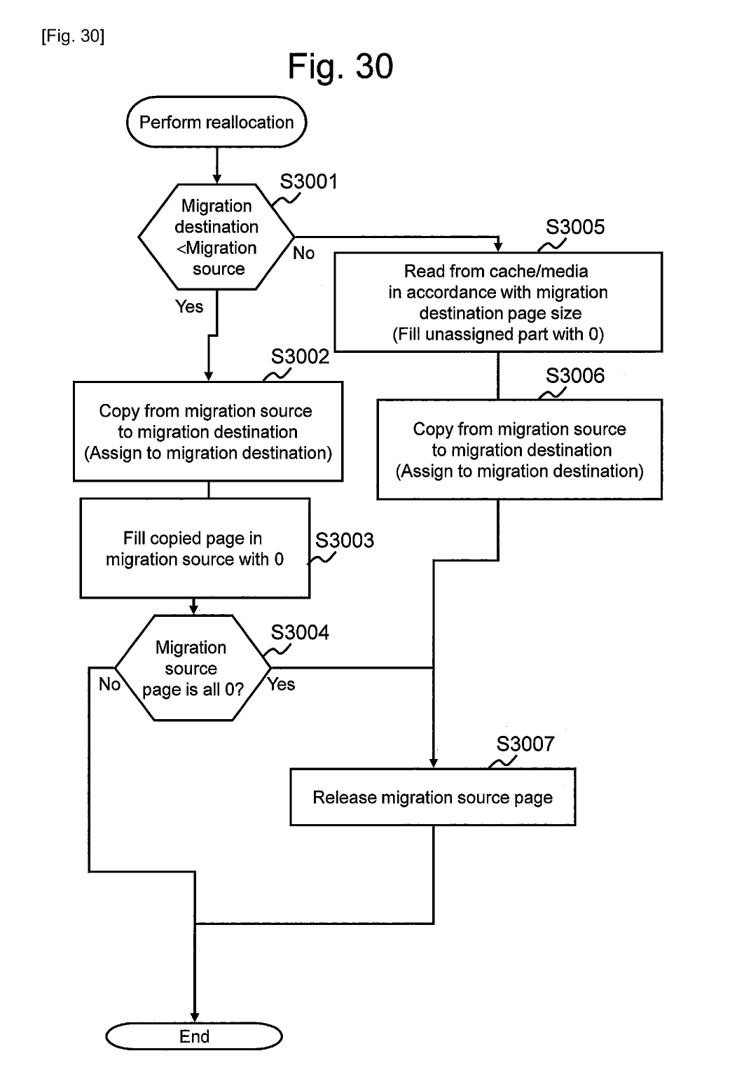

The reallocation program 516 performs data migration from a page (or a page area) to another page in accordance with the statistical entry group 502. In the explanation of FIG. 29 and FIG. 30, the data migration source page (or page area) might be referred to as a migration source page (or migration source page area), and the data migration destination page (or page area) might be referred to as a migration destination page (or migration destination page area)

(S2901)

The program 516 performs the reallocation list update processing. Specifically speaking, for example, the program 516, for each tier, performs the processing described below (hereinafter, one medium tier T is explained as an example):

(2901-1) identifying the I/O frequencies of all the pages (K pages) belonging to the tier T (K indicates an integral number which is 2 or larger);

(2901-2) sorting the identified K I/O frequencies;

(2901-3) identifying the minimum value of two or more I/O frequencies belonging to the higher A percent of the K units of I/O frequencies and the maximum value of two or more I/O frequencies belonging to the lower B percent of the K units of I/O frequencies; and,

(2901-4) as an I/O frequency range 703 corresponding to the tier T (refer to FIG. 7), registering the minimum value (higher threshold) and the maximum value (lower threshold) identified at the above-mentioned (2901-3).

The above-mentioned (2901-4) is equivalent to the feedback of the result of the processing complying with the above-mentioned (2901-2). The I/O frequency threshold 703 is updated each time S2901 is performed for the tier. It should be noted that the I/O frequency of one page is ascertained in accordance with the plurality of 1/m counters assigned to the page at the above-mentioned (2901-1). If a page area to a page of which no 1/m counter is assigned exists, in accordance with the one or more 1/m counters assigned to the page, the I/O frequency for the page area to which no 1/m counter is assigned may be determined. In this reallocation list update processing, the reallocation management table 510 is constructed.

(S2902)

The program 516 performs the reallocation processing (refer to FIG. 30) for each tier. In the reallocation processing, the program 516 migrates the data in a page corresponding to the I/O frequency exceeding the higher threshold to a page in a tier higher than the tier to which the page belongs. Furthermore, in the reallocation processing, the program 516 migrates the data in a page corresponding to the I/O frequency exceeding the lower threshold to a page in a tier lower than the tier to which the page belongs.

(S2903)

The program 516 determines for each migration source page area whether a 1/m counter is assigned to the migration source page area or not. If the result of the determination is affirmative (S2903: Yes), S2904 is performed. If the result of the determination is negative (S2903: No), instead of S2904, S2905 is performed.

(S2904)

The program 516 collects the 1/m counter assigned to the migration source page area (makes the same unassigned).

(S2905)

The program 516 assigns the unassigned 1/m counter to the migration destination page area. It should be noted that, if the migration destination page area belongs to the highest tier, this S2905 does not have to be performed.

(S2906)

The program 516 determines for each migration source page whether all of the M migration source pages associated with the statistical entry are released from the assignment or not. If the result of the determination is affirmative (S2906: Yes), the processing is terminated. If the result of the determination is negative (S2906: No), S2907 is performed.

(S2907)

The program 516 releases the statistical entry corresponding to the M migration source pages which are released from the assignment.

FIG. 30 shows the flow of the reallocation processing (S2902 in FIG. 29).

(S3001)

The program 516 determines whether the size of the migration source page is larger than the size of the migration destination page or not. If the result of the determination is affirmative (S3001: Yes), S3002 is performed. If the result of the determination is negative (S3001: No), S3005 is performed. It should be noted that the “migration source page” is a page including a page area (migration source page area) to which a 1/m counter indicating the I/O frequency over the higher threshold or below the lower threshold is assigned. Furthermore, the “migration destination page” is a page corresponding to any of the unassigned pages (pages not assigned to any VVOL) in the tier higher or lower than the tier to which the migration source page area belongs.

(S3002)

The program 516 copies the data from the migration source page area to one or more migration destination pages. The program 516 assigns one or more migration destination pages to the virtual area to which the migration source page was assigned.

(S3003)

The program 516 writes a bit value “0” to the entire area in the migration source page area. An invalid data other than 0 may also be adopted.

(S3004)

The program 516 determines whether the entire area in the migration source page is filled with 0 or not. If the result of the determination is affirmative (S3004: Yes), S3007 is performed. If the result of the determination is negative (S3004: No), the processing is terminated.

(S3005)

The program 516 reads the data from the migration source page to the CMPK 119. To the entire area which the read data does not occupy in the range of the migration destination page, the bit value “0” is written. By this method, it is considered that the migration target data including the plurality of bit values “0” and the data read from the migration source page is created in the CMPK 119.

(S3006)

The program 516 copies the migration target data to the migration destination page. The program 516 assigns the migration destination page to the virtual area to which the migration source page was assigned.

(S3007)

The program 516 releases the assignment to the virtual area of the migration source page. By this method, for example, the direct page entry corresponding to the migration source page is excluded from the page entry group 501.

### Embodiment 2

Hereinafter, the Embodiment 2 of the present invention is explained. In the course, the differences from the Embodiment 1 are mainly explained, and the explanation of what is common to the Embodiment 1 is omitted or simplified (which is applied to the Embodiment 3 and later).

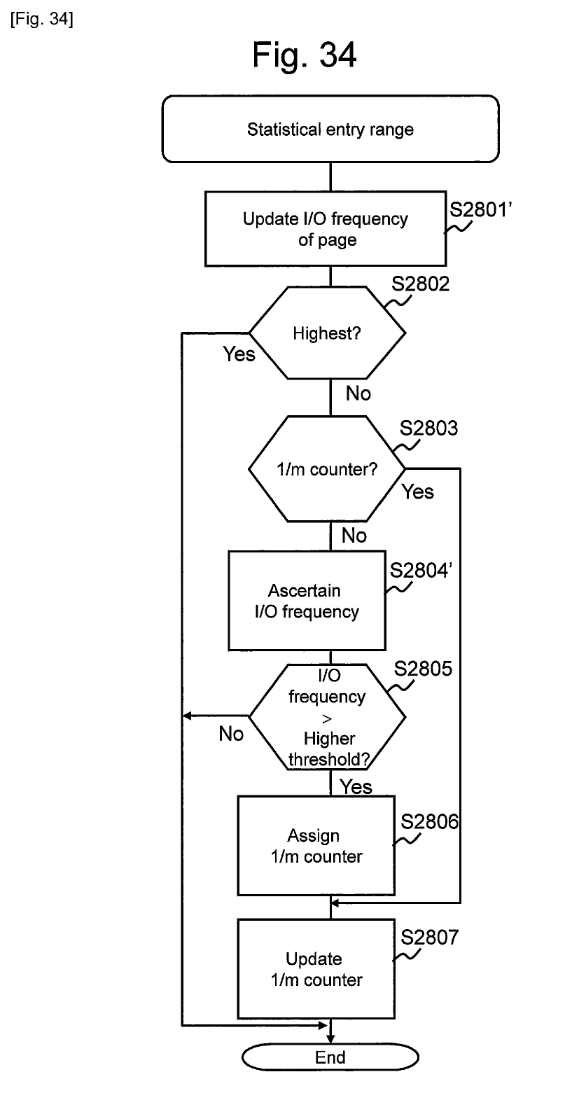

FIG. 34 shows the flow of the statistical entry processing related to the Embodiment 2.

The difference of FIG. 34 from FIG. 28 is that S2801 is S2801′ and that S2804 is S2804′. Specifically speaking, in the Embodiment 2, instead of the I/O frequency corresponding to the VVOL, the I/O frequency corresponding to M pages is adopted.

At S2801′, the I/O processing program 513 updates the I/O frequency corresponding to the M pages including the I/O destination page (the I/O frequency in the statistical entry corresponding to the I/O address).

At S2804′, the I/O processing program 513 ascertains the I/O frequency corresponding to the I/O destination page area by dividing the I/O frequency corresponding to the M pages including the I/O destination page (I/O frequency updated at S2801′) by the total amount of the M pages (e.g. the total number of page areas which the M pages comprise).

### Embodiment 3

Hereinafter, the Embodiment 3 of the present invention is explained.

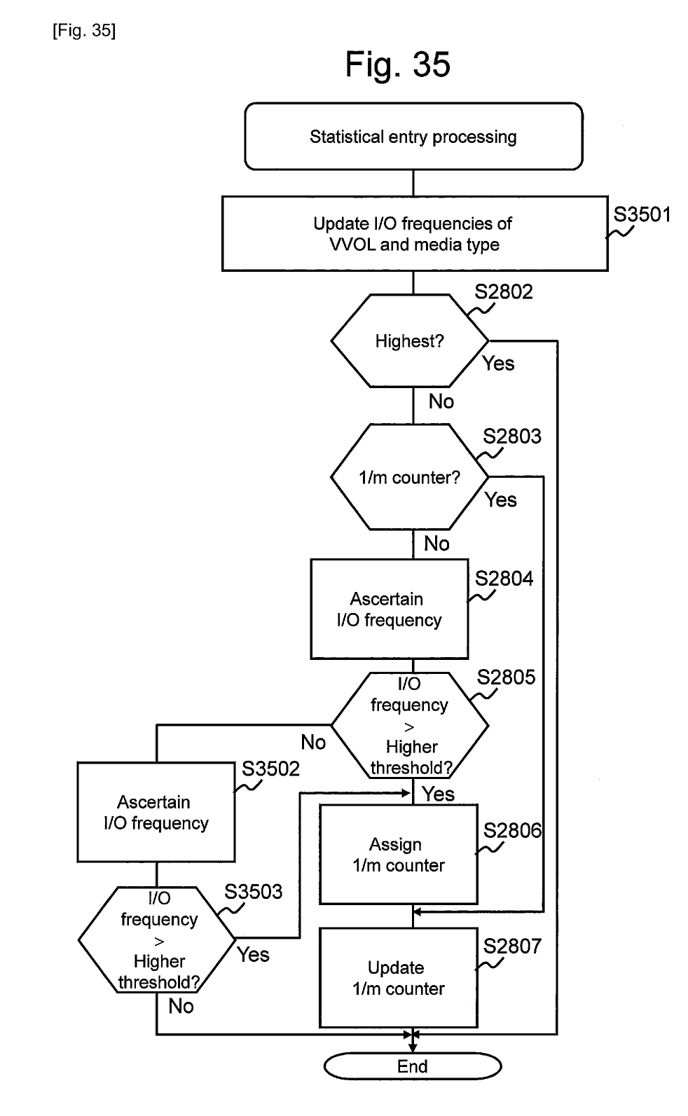

FIG. 35 shows the flow of the statistical entry processing related to the Embodiment 3.

The difference of FIG. 35 from FIG. 28 is that S2801 is S3501 and that S3502 and

S3503 are added. Specifically speaking, in the Embodiment 3, in addition to the I/O frequency 1106 per VVOL (refer to FIG. 10), the I/O frequency 1202 per media type (refer to FIG. 12) is also used.

(S3501)

The I/O processing program 513, in addition to the I/O frequency 1106 (refer to FIG. 10) corresponding to the I/O destination VVOL (VVOL specified by the I/O command), updates the I/O frequency 1202 (refer to FIG. 12) corresponding to the media type to which the I/O destination page belongs.

If the result of the determination at S2805 is negative (S2805: No), S3502 is performed.

(S3502)

The I/O processing program 513 ascertains the I/O frequency corresponding to the I/O destination page area by dividing the I/O frequency 1202 corresponding to the media type of the tier to which the I/O destination page belongs (the I/O frequency updated at S3501) by the total amount of assigned pages based on the media type (e.g. the total number of page areas which the assigned pages comprise).

(S3503)

The program 513 determines whether the I/O frequency ascertained at S3502 is over the higher threshold for the tier to which the I/O destination page belongs or not. If the result of the determination is affirmative (S3503: Yes), S2806 is performed. If the result of the determination is negative (S3503: No), the processing is terminated.

### Embodiment 4

Hereinafter, the Embodiment 4 of the present invention is explained.

In this embodiment, the management apparatus 107 ascertains the supportable capacity per tier in the pool VOL addition and displays the ascertained supportable capacity on the display device 159. This enables the administrator to add pool VOLs within the range of the supportable capacity for each of the tiers. Specifically speaking, the load on the administrator can be reduced.

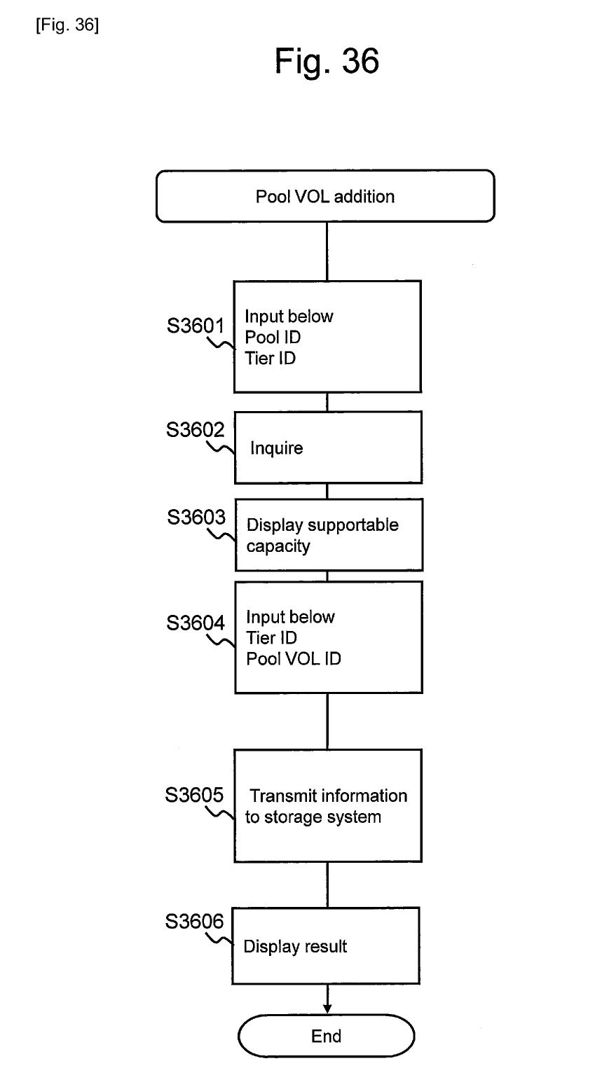

FIG. 36 shows the flow of the processing performed if the request at S1801 of FIG. 18 is a pool VOL addition request in the Embodiment 4.

(S3601)

The pool setting program 401 accepts the input of a pool ID and a tier ID via the input device 157.

(S3602)

The program 401 transmits the queries (a) and (b) described below to the storage system 103:

(a) the number of free entries (the number of page entries and statistical entries in the free entry group 506); and
(b) the setting parameter group (the parameter group of each tier associated with the pool management table 506 (e.g. the capacity ratio, the page size, and the statistical range)).

The queries include the pool ID and the tier ID input at S3601. The program 401 receives the response to the queries (the number of free entries and the setting parameter group corresponding to each of the input tier IDs) from the storage system 103 (e.g. the pool management program 514).

(S3603)

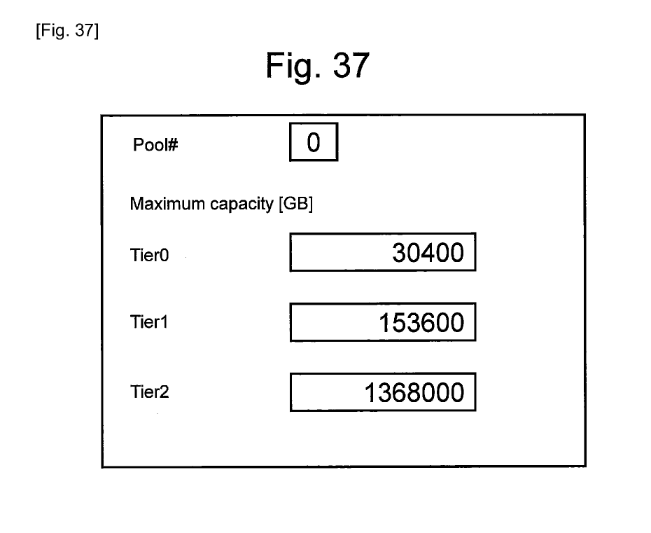

The program 401 ascertains the supportable capacity per tier ID input at S3601 in accordance with the above-mentioned (a) and (b) responded from the storage system 103, and displays the ascertained supportable capacity of each tier ID (refer to FIG. 37). The supportable capacity for a tier is a maximum capacity that can be added to the tier. The program 401 does not accept the addition of the pool VOLs exceeding the ascertained supportable capacity for each of the tiers. For example, if the addition of the pool VOLs exceeding the ascertained supportable capacity is required by the administrator, the program 401 may display the information indicating an error on the display device 159.

(S3604)

The pool setting program 401 accepts the input of a tier ID and a pool VOL ID via the input device 157. The accepted pool VOL ID is the ID of a pool VOL which does not exceed the ascertained supportable capacity for a tier corresponding to the input tier ID.

(S3605)

The program 401 transmits a pool VOL addition request including the input pool ID, tier ID and pool VOL ID to the storage system 103.

(S3606)

The program 401 displays the information indicating the result of S3605 (e.g. the result information from the storage system 103) on the display device 159.

Though some of the embodiments of the present invention are explained as above, it is obvious that the present invention is not limited to these embodiments and that various changes and modifications may be made without departing from the spirit and scope whereof.

### REFERENCE SIGN LIST

103: Storage system

1. A storage control system that provides a virtual volume, which is a virtual logical volume complying with Thin Provisioning, the storage control system comprising:
a storage resource; and
a controller, which is coupled to this storage resource, wherein the controller, upon receiving a write command, which specifies an address belonging to the virtual volume, assigns to an area belonging to the address an unassigned page, which is a storage area based on physical storage media of P media types (where P is an integral number which is 2 or larger), and is in a pool that has been partitioned into a plurality of pages,
the storage resource comprises a plurality of management entries, which are a plurality of entries for page management information, which is page-related information,
the plurality of management entries comprise two or more page entries, and two or more statistical entries,
the page entry for each media type is formed in accordance with a prescribed size and corresponds to one page,
a statistical entry for a certain media type corresponds to M pages (where M is an integral number which is 2 or larger) based on the storage media of the certain media type, and
statistical entries corresponding to M pages comprise information related to I/O performance values with respect to these M pages.

2. A storage control system according to claim 1, wherein
the size of a page, which is based on a storage media of the media type belonging to a lower tier, is larger than the size of a page, which is based on a storage media of the media type belonging to a higher tier, the storage resource comprises a plurality of page area counters,
a page of a size that is larger than a page of the smallest page size comprises m page areas (where m is an integral number which is 2 or larger), and the value of m is the same value as the quotient obtained by dividing the size of the page comprising this page area by the smallest page size,
the page area counter is a counter, which is assigned to a page area, and which expresses an I/O performance value with respect to the assigned page area, and
the controller, in a case where the I/O performance value expressed by the page area counter either exceeds or falls below an I/O performance threshold with respect to a first tier, to which a first page area assigned with this page area counter belongs, migrates data in the first page area to a page belonging to a second tier, which differs from the first tier.

3. A storage control system according to claim 2, wherein the statistical entry comprises yes/no information denoting whether or not a page area counter has been assigned as information related to an I/O performance value, and wherein
the controller:
(3-1) infers, in a case where identification is made that a page area counter has not been assigned from the yes/no information of the statistical entry corresponding to the I/O-destination page, the I/O performance value of the I/O destination page area; and
(3-2) assigns, in a case where the I/O performance value inferred in the (3-1) exceeds a high threshold, which is a threshold with respect to a third tier to which the I/O-destination page area belongs and is a threshold indicating whether or not data is to be migrated to a tier that is higher than the third tier, an unassigned page area counter from among the plurality of page area counters to the I/O-destination page area.

4. A storage control system according to claim 3, wherein the controller determines a new higher threshold based on I/O performance values with respect to a plurality of pages belonging to the third tier, and the higher threshold used in the (3-2) is the determined threshold.

5. A storage control system according to claim 3, wherein the I/O performance value inferred in the (3-1) is a value inferred based on the virtual volume I/O performance value and the virtual volume capacity.

6. A storage control system according to claim 3, wherein
as information related to I/O performance values, the statistical entries associated with M pages comprise I/O performance values with respect to these M page, and
the I/O performance value inferred in the (3-1) is a value inferred based on the total page area of the M pages and I/O performance values with respect to M pages, which include the page comprising the I/O-destination page area.

7. A storage control system according to claim 3, wherein
the controller, in a case where the I/O performance value inferred in the (3-1) does not exceed the higher threshold with respect to the third tier in the (3-2):
(7-1) infers the I/O performance value of the I/O-destination page area based on the I/O performance value with respect to the media type belonging to the third tier, and the total page area of all the pages based on the storage media of the media type belonging to the third tier; and (7-2) assigns, in a case where the I/O performance value inferred in the (7-1) exceeds the higher threshold with respect to the third tier, an unassigned page area counter from among the plurality of page area counters to the I/O-destination page area.

8. A storage control system according to claim 1, further comprising a management apparatus, which is coupled to the controller, wherein this management apparatus, upon receiving an input of a value M with respect to each of (P−1) media types, computes the number of usable statistical entries with respect to the remaining one media type based on the capacity of each media type and value M of each of the (P−1) media types, and accepts the input of a value M not allowing more statistical entries than the number of computed statistical entries to be used, but does not accept the input of a value M allowing more statistical entries than the number of computed statistical entries to be used.

9. A storage control system according to claim 1, wherein the management apparatus, upon receiving a page size input with respect to each of (P−1) media types, computes the number of usable page entries with respect to the one remaining media type based on the capacity of each media type and the page size of each of the (P−1) media types, and accepts the input of a page size allowing more page entries than the number of computed page entries to be used, but does not accept the input of a page size when allowing more page entries than the number of computed page entries to be used.

10. A method of setting information in a storage control apparatus that provides a virtual volume, which is a virtual logical volume complying with Thin Provisioning,
with the storage control apparatus being configured such that this apparatus, upon receiving a write command that specifies an address belonging to the virtual volume, assigns to an area belonging to the address an unassigned page, which is a storage area based on physical storage media of P media types (where P is an integral number of 2 or larger), and is in a pool that has been partitioned into a plurality of pages,
this apparatus comprises a storage resource, and the storage resource comprises a plurality of management entries, which are a plurality of entries for page management information, which is page-related information,
the plurality of management entries comprises two or more page entries and two or more statistical entries,
the page entry for each media type is formed in accordance with the a prescribed size and corresponds to one page,
a statistical entry for a certain media type corresponds to M pages (where M is an integral number of 2 or larger) based on the storage media of the certain media type, and
statistical entries corresponding to M pages comprise information related to I/O performance values with respect to these M pages, the information setting method comprising:
(A) receiving by a management apparatus the input of a value M with respect to each of (P−1) media types;
(B) computing the number of usable statistical entries with respect to one remaining media type based on the capacity of each media type and the value M for each of the (P−1) media types;
(C) accepting the input of the value M not allowing a statistical entry that is larger than the number of computed statistical entries to be used, but not accepting the input of value M allowing a statistical entry that is larger than the number of computed statistical entries to be used; and
(D) setting the value M with respect to the inputted P media types in the storage control apparatus.
